(19) United States
(12) Patent Application Publication
(10) Pub. No.: US 2022/0337814 A1
(43) Pub. Date: Oct. 20, 2022

(54) IMAGE ENCODING/DECODING METHOD AND DEVICE USING REFERENCE SAMPLE FILTERING, AND METHOD FOR TRANSMITTING BITSTREAM

(71) Applicant: LG ELECTRONICS INC., Seoul (KR)

(72) Inventors: Jin HEO, Seoul (KR); Jangwon CHOI, Seoul (KR); Jung Hak NAM, Seoul (KR); Hyeong Moon JANG, Seoul (KR); Moonmo KOO, Seoul (KR)

(21) Appl. No.: 17/760,676

(22) PCT Filed: Sep. 21, 2020
(86) PCT No.: PCT/KR2020/012723

§ 371 Date: Mar. 15, 2022

Related U.S. Application Data
(60) Provisional application No. 62/902,923, filed on Sep. 19, 2019.
(60) Provisional application No. 62/905,415, filed on Sep. 25, 2019.
(60) Provisional application No. 62/906,741, filed on Sep. 27, 2019.
(60) Provisional application No. 62/951,923, filed on Dec. 20, 2019.

(51) Int. Cl. H04N 19/105; H04N 19/132; H04N 19/117; H04N 19/159; H04N 19/176

(52) U.S. Cl. CPC H04N 19/105; H04N 19/132; H04N 19/117; H04N 19/159; H04N 19/176

(57) ABSTRACT

An image encoding/decoding method and apparatus are provided. An image decoding method according to the present disclosure is performed by an image decoding apparatus. The image decoding method may comprise determining an intra prediction mode of a current block, determining a reference sample based on the intra prediction mode and a neighboring sample of the current block, generating the prediction block based on the reference sample, and decoding the current block based on the prediction block. The reference sample may be determined by applying at least one of first filtering or second filtering to the neighboring sample value based on the intra prediction mode.

### TECHNICAL FIELD

The present disclosure relates to an image encoding/decoding method and apparatus, and, more particularly, to a method and apparatus for encoding/decoding an image using reference sample filtering, and a method of transmitting a bitstream generated by the image encoding method/apparatus of the present disclosure.

### BACKGROUND ART

Recently, demand for high-resolution and high-quality images such as high definition (HD) images and ultra high definition (UHD) images is increasing in various fields. As resolution and quality of image data are improved, the amount of transmitted information or bits relatively increases as compared to existing image data. An increase in the amount of transmitted information or bits causes an increase in transmission cost and storage cost.

Accordingly, there is a need for high-efficient image compression technology for effectively transmitting, storing and reproducing information on high-resolution and high-quality images.

### DISCLOSURE

### Technical Problem

An object of the present disclosure is to provide an image encoding/decoding method and apparatus with improved encoding/decoding efficiency.

Another object of the present disclosure is to provide an image encoding/decoding method and apparatus capable of improving encoding/decoding efficiency by improving a reference sample filtering condition.

Another object of the present disclosure is to provide a method of transmitting a bitstream generated by an image encoding method or apparatus according to the present disclosure.

Another object of the present disclosure is to provide a recording medium storing a bitstream generated by an image encoding method or apparatus according to the present disclosure.

Another object of the present disclosure is to provide a recording medium storing a bitstream received, decoded and used to reconstruct an image by an image decoding apparatus according to the present disclosure.

The technical problems solved by the present disclosure are not limited to the above technical problems and other technical problems which are not described herein will become apparent to those skilled in the art from the following description.

### Technical Solution

An image decoding method performed by an image decoding apparatus according to an aspect of the present disclosure may comprise determining an intra prediction mode of a current block, determining a reference sample based on the intra prediction mode and a neighboring sample of the current block, generating the prediction block based on the reference sample, and decoding the current block based on the prediction block. The reference sample may be determined by applying at least one of first filtering or second filtering to the neighboring sample value based on the intra prediction mode.

An image decoding apparatus according to an aspect of the present disclosure may include a memory and at least one processor. The at least one processor may determine an intra prediction mode of a current block, determine a reference sample based on the intra prediction mode and a neighboring sample of the current block, generate the prediction block based on the reference sample, and decode the current block based on the prediction block. The reference sample may be determined by applying at least one of first filtering or second filtering to the neighboring sample value based on the intra prediction mode.

An image encoding method performed by an image encoding apparatus according to an aspect of the present disclosure may comprises determining an intra prediction mode of a current block, determining a reference sample based on the intra prediction mode and a neighboring sample of the current block, generating the prediction block based on the reference sample, and encoding the current block based on the prediction block. The reference sample may be determined by applying at least one of first filtering or second filtering to the neighboring sample value based on the intra prediction mode.

In addition, a transmission method according to another aspect of the present disclosure may transmit a bitstream generated by the image encoding apparatus or the image encoding method of the present disclosure.

In addition, a computer-readable recording medium according to another aspect of the present disclosure may store the bitstream generated by the image encoding apparatus or the image encoding method of the present disclosure.

The features briefly summarized above with respect to the present disclosure are merely exemplary aspects of the detailed description below of the present disclosure, and do not limit the scope of the present disclosure.

### Advantageous Effects

According to the present disclosure, it is possible to provide an image encoding/decoding method and apparatus with improved encoding/decoding efficiency.

Also, according to the present disclosure, it is possible to provide an image encoding/decoding method and apparatus capable of improving encoding/decoding efficiency by improving a reference sample filtering condition.

Also, according to the present disclosure, it is possible to provide a method of transmitting a bitstream generated by an image encoding method or apparatus according to the present disclosure.

Also, according to the present disclosure, it is possible to provide a recording medium storing a bitstream generated by an image encoding method or apparatus according to the present disclosure.

Also, according to the present disclosure, it is possible to provide a recording medium storing a bitstream received, decoded and used to reconstruct an image by an image decoding apparatus according to the present disclosure.

It will be appreciated by persons skilled in the art that that the effects that can be achieved through the present disclosure are not limited to what has been particularly described hereinabove and other advantages of the present disclosure will be more clearly understood from the detailed description.

### DESCRIPTION OF DRAWINGS

FIG. 1 is a view schematically showing a video coding system, to which an embodiment of the present disclosure is applicable.

FIG. 2 is a view schematically showing an image encoding apparatus, to which an embodiment of the present disclosure is applicable.

FIG. 3 is a view schematically showing an image decoding apparatus, to which an embodiment of the present disclosure is applicable.

FIG. 4 is a view showing a partitioning structure of an image according to an embodiment.

FIG. 5 is a view showing an embodiment of a splitting type of a block according to a multi-type tree structure.

FIG. 6 is a view showing a signaling mechanism of block splitting information in a quadtree with nested multi-type tree structure according to the present disclosure.

FIG. 7 is a view showing an embodiment in which a CTU is partitioned into multiple CUs.

FIG. 8 is a block diagram of a CABAC according to an embodiment for encoding one syntax element.

FIGS. 9 to 12 are views illustrating entropy encoding and decoding according to an embodiment.

FIGS. 13 and 14 are views illustrating an example of a picture decoding and encoding procedure according to an embodiment.

FIG. 15 is a view illustrating a hierarchical structure for a coded image according to an embodiment.

FIG. 16 is a view illustrating a neighboring reference sample according to an embodiment.

FIGS. 17 to 18 are views illustrating intra prediction according to an embodiment.

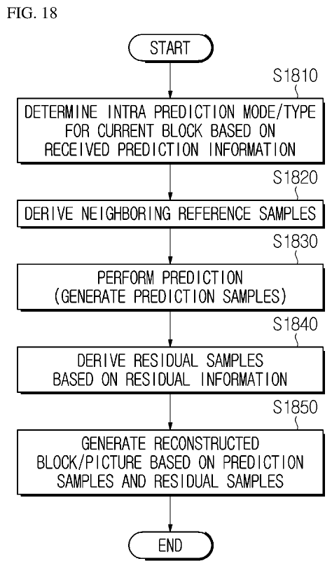

FIGS. 19 to 20 are views illustrating an intra prediction direction according to an embodiment.

FIG. 21 is a view an intra prediction process according to an embodiment.

FIG. 22 is a view illustrating a neighboring reference sample in a planar mode according to an embodiment.

FIGS. 23 and 24 are views illustrating operation of an encoding apparatus and a decoding apparatus according to an embodiment.

FIG. 25 is a view showing a content streaming system, to which an embodiment of the present disclosure is applicable.

### MODE FOR INVENTION

Hereinafter, the embodiments of the present disclosure will be described in detail with reference to the accompanying drawings so as to be easily implemented by those skilled in the art. However, the present disclosure may be implemented in various different forms, and is not limited to the embodiments described herein.

In describing the present disclosure, if it is determined that the detailed description of a related known function or construction renders the scope of the present disclosure unnecessarily ambiguous, the detailed description thereof will be omitted. In the drawings, parts not related to the description of the present disclosure are omitted, and similar reference numerals are attached to similar parts.

In the present disclosure, when a component is “connected”, “coupled” or “linked” to another component, it may include not only a direct connection relationship but also an indirect connection relationship in which an intervening component is present. In addition, when a component “includes” or “has” other components, it means that other components may be further included, rather than excluding other components unless otherwise stated.

In the present disclosure, the terms first, second, etc. may be used only for the purpose of distinguishing one component from other components, and do not limit the order or importance of the components unless otherwise stated. Accordingly, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly describe each feature, and do not mean that the components are necessarily separated. That is, a plurality of components may be integrated and implemented in one hardware or software unit, or one component may be distributed and implemented in a plurality of hardware or software units. Therefore, even if not stated otherwise, such embodiments in which the components are integrated or the component is distributed are also included in the scope of the present disclosure.

In the present disclosure, the components described in various embodiments do not necessarily mean essential components, and some components may be optional components. Accordingly, an embodiment consisting of a subset of components described in an embodiment is also included in the scope of the present disclosure. In addition, embodiments including other components in addition to components described in the various embodiments are included in the scope of the present disclosure.

The present disclosure relates to encoding and decoding of an image, and terms used in the present disclosure may have a general meaning commonly used in the technical field, to which the present disclosure belongs, unless newly defined in the present disclosure.

In the present disclosure, a “picture” generally refers to a unit representing one image in a specific time period, and a slice/tile is a coding unit constituting a part of a picture, and one picture may be composed of one or more slices/tiles. In addition, a slice/tile may include one or more coding tree units (CTUs). Meanwhile, one tile may include one or more bricks. The brick may represent a rectangular region of CTU rows in a tile. One tile may be split into a plurality of bricks, and each brick may include one or more CTU rows belonging to a tile.

In the present disclosure, a “pixel” or a “pel” may mean a smallest unit constituting one picture (or image). In addition, “sample” may be used as a term corresponding to a pixel. A sample may generally represent a pixel or a value of a pixel, and may represent only a pixel/pixel value of a luma component or only a pixel/pixel value of a chroma component.

In the present disclosure, a “unit” may represent a basic unit of image processing. The unit may include at least one of a specific region of the picture and information related to the region. The unit may be used interchangeably with terms such as “sample array”, “block” or “area” in some cases. In a general case, an M×N block may include samples (or sample arrays) or a set (or array) of transform coefficients of M columns and N rows.

In the present disclosure, “current block” may mean one of “current coding block”, “current coding unit”, “coding target block”, “decoding target block” or “processing target block”. When prediction is performed, “current block” may mean “current prediction block” or “prediction target block”. When transform (inverse transform)/quantization (dequantization) is performed, “current block” may mean “current transform block” or “transform target block”. When filtering is performed, “current block” may mean “filtering target block”.

In addition, in the present disclosure, a “current block” may mean “a luma block of a current block” unless explicitly stated as a chroma block. The “chroma block of the current block” may be expressed by including an explicit description of a chroma block, such as “chroma block” or “current chroma block”.

In the present disclosure, the term “/” and “,” should be interpreted to indicate “and/or.” For instance, the expression “A/B” and “A, B” may mean “A and/or B.” Further, “A/B/C” and “A/B/C” may mean “at least one of A, B, and/or C.”

In the present disclosure, the term “or” should be interpreted to indicate “and/or.” For instance, the expression “A or B” may comprise 1) only “A”, 2) only “B”, and/or 3) both “A and B”. In other words, in the present disclosure, the term “or” should be interpreted to indicate “additionally or alternatively.”

Overview of Video Coding System

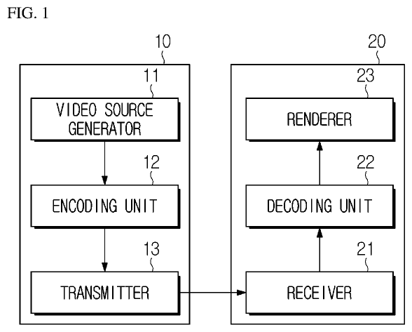

FIG. 1 is a view showing a video coding system according to the present disclosure.

The video coding system according to an embodiment may include a encoding apparatus 10 and a decoding apparatus 20. The image encoding apparatus 10 may deliver encoded video and/or image information or data to the image decoding apparatus 20 in the form of a file or streaming via a digital storage medium or network.

The image encoding apparatus 10 according to an embodiment may include a video source generator 11, an encoding unit 12 and a transmitter 13. The image decoding apparatus 20 according to an embodiment may include a receiver 21, a decoding unit 22 and a renderer 23. The encoding unit 12 may be called a video/image encoding unit, and the decoding unit 22 may be called a video/image decoding unit. The transmitter 13 may be included in the encoding unit 12. The receiver 21 may be included in the decoding unit 22. The renderer 23 may include a display and the display may be configured as a separate device or an external component.

The video source generator 11 may acquire a video/image through a process of capturing, synthesizing or generating the video/image. The video source generator 11 may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding unit 12 may encode an input video/image. The encoding unit 12 may perform a series of procedures such as prediction, transform, and quantization for compression and coding efficiency. The encoding unit 12 may output encoded data (encoded video/image information) in the form of a bitstream.

The transmitter 13 may transmit the encoded video/image information or data output in the form of a bitstream to the receiver 21 of the image decoding apparatus 20 through a digital storage medium or a network in the form of a file or streaming. The digital storage medium may include various storage mediums such as USB, SD, CD, DVD, Blu-ray, HDD, SSD, and the like. The transmitter 13 may include an element for generating a media file through a predetermined file format and may include an element for transmission through a broadcast/communication network. The receiver 21 may extract/receive the bitstream from the storage medium or network and transmit the bitstream to the decoding unit 22.

The decoding unit 22 may decode the video/image by performing a series of procedures such as dequantization, inverse transform, and prediction corresponding to the operation of the encoding unit 12.

The renderer 23 may render the decoded video/image. The rendered video/image may be displayed through the display.

Overview of Image Encoding Apparatus

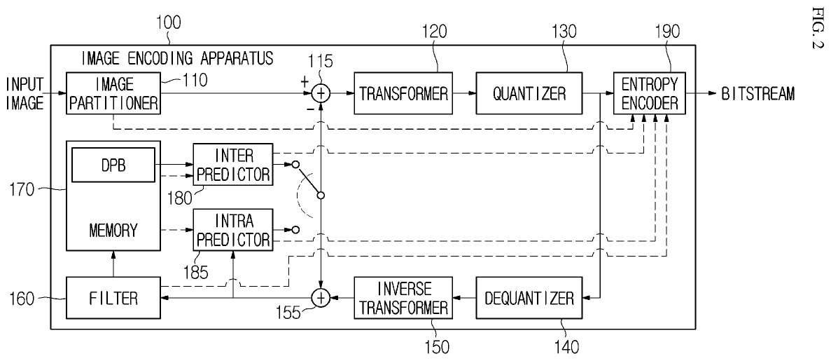

FIG. 2 is a view schematically showing an image encoding apparatus, to which an embodiment of the present disclosure is applicable.

As shown in FIG. 2, the image encoding apparatus 100 may include an image partitioner 110, a subtractor 115, a transformer 120, a quantizer 130, a dequantizer 140, an inverse transformer 150, an adder 155, a filter 160, a memory 170, an inter prediction unit 180, an intra prediction unit 185 and an entropy encoder 190. The inter prediction unit 180 and the intra prediction unit 185 may be collectively referred to as a “prediction unit”. The transformer 120, the quantizer 130, the dequantizer 140 and the inverse transformer 150 may be included in a residual processor. The residual processor may further include the subtractor 115.

All or at least some of the plurality of components configuring the image encoding apparatus 100 may be configured by one hardware component (e.g., an encoder or a processor) in some embodiments. In addition, the memory 170 may include a decoded picture buffer (DPB) and may be configured by a digital storage medium.

The image partitioner 110 may partition an input image (or a picture or a frame) input to the image encoding apparatus 100 into one or more processing units. For example, the processing unit may be called a coding unit (CU). The coding unit may be acquired by recursively partitioning a coding tree unit (CTU) or a largest coding unit (LCU) according to a quad-tree binary-tree ternary-tree (QT/BT/TT) structure. For example, one coding unit may be partitioned into a plurality of coding units of a deeper depth based on a quad tree structure, a binary tree structure, and/or a ternary structure. For partitioning of the coding unit, a quad tree structure may be applied first and the binary tree structure and/or ternary structure may be applied later. The coding procedure according to the present disclosure may be performed based on the final coding unit that is no longer partitioned. The largest coding unit may be used as the final coding unit or the coding unit of deeper depth acquired by partitioning the largest coding unit may be used as the final coding unit. Here, the coding procedure may include a procedure of prediction, transform, and reconstruction, which will be described later. As another example, the processing unit of the coding procedure may be a prediction unit (PU) or a transform unit (TU). The prediction unit and the transform unit may be split or partitioned from the final coding unit. The prediction unit may be a unit of sample prediction, and the transform unit may be a unit for deriving a transform coefficient and/or a unit for deriving a residual signal from the transform coefficient.

The prediction unit (the inter prediction unit 180 or the intra prediction unit 185) may perform prediction on a block to be processed (current block) and generate a predicted block including prediction samples for the current block. The prediction unit may determine whether intra prediction or inter prediction is applied on a current block or CU basis. The prediction unit may generate various information related to prediction of the current block and transmit the generated information to the entropy encoder 190. The information on the prediction may be encoded in the entropy encoder 190 and output in the form of a bitstream.

The intra prediction unit 185 may predict the current block by referring to the samples in the current picture. The referred samples may be located in the neighborhood of the current block or may be located apart according to the intra prediction mode and/or the intra prediction technique. The intra prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra prediction unit 185 may determine the prediction mode applied to the current block by using a prediction mode applied to a neighboring block.

The inter prediction unit 180 may derive a predicted block for the current block based on a reference block (reference sample array) specified by a motion vector on a reference picture. In this case, in order to reduce the amount of motion information transmitted in the inter prediction mode, the motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like. The reference picture including the temporal neighboring block may be called a collocated picture (colPic). For example, the inter prediction unit 180 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter prediction unit 180 may use motion information of the neighboring block as motion information of the current block. In the case of the skip mode, unlike the merge mode, the residual signal may not be transmitted. In the case of the motion vector prediction (MVP) mode, the motion vector of the neighboring block may be used as a motion vector predictor, and the motion vector of the current block may be signaled by encoding a motion vector difference and an indicator for a motion vector predictor. The motion vector difference may mean a difference between the motion vector of the current block and the motion vector predictor.

The prediction unit may generate a prediction signal based on various prediction methods and prediction techniques described below. For example, the prediction unit may not only apply intra prediction or inter prediction but also simultaneously apply both intra prediction and inter prediction, in order to predict the current block. A prediction method of simultaneously applying both intra prediction and inter prediction for prediction of the current block may be called combined inter and intra prediction (CIIP). In addition, the prediction unit may perform intra block copy (IBC) for prediction of the current block. Intra block copy may be used for content image/video coding of a game or the like, for example, screen content coding (SCC). IBC is a method of predicting a current picture using a previously reconstructed reference block in the current picture at a location apart from the current block by a predetermined distance. When IBC is applied, the location of the reference block in the current picture may be encoded as a vector (block vector) corresponding to the predetermined distance. IBC basically performs prediction in the current picture, but may be performed similarly to inter prediction in that a reference block is derived within the current picture. That is, IBC may use at least one of the inter prediction techniques described in the present disclosure.

The prediction signal generated by the prediction unit may be used to generate a reconstructed signal or to generate a residual signal. The subtractor 115 may generate a residual signal (residual block or residual sample array) by subtracting the prediction signal (predicted block or prediction sample array) output from the prediction unit from the input image signal (original block or original sample array). The generated residual signal may be transmitted to the transformer 120.

The transformer 120 may generate transform coefficients by applying a transform technique to the residual signal. For example, the transform technique may include at least one of a discrete cosine transform (DCT), a discrete sine transform (DST), a karhunen-loeve transform (KLT), a graph-based transform (GBT), or a conditionally non-linear transform (CNT). Here, the GBT means transform obtained from a graph when relationship information between pixels is represented by the graph. The CNT refers to transform acquired based on a prediction signal generated using all previously reconstructed pixels. In addition, the transform process may be applied to square pixel blocks having the same size or may be applied to blocks having a variable size rather than square.

The quantizer 130 may quantize the transform coefficients and transmit them to the entropy encoder 190. The entropy encoder 190 may encode the quantized signal (information on the quantized transform coefficients) and output a bitstream. The information on the quantized transform coefficients may be referred to as residual information. The quantizer 130 may rearrange quantized transform coefficients in a block form into a one-dimensional vector form based on a coefficient scanning order and generate information on the quantized transform coefficients based on the quantized transform coefficients in the one-dimensional vector form.

The entropy encoder 190 may perform various encoding methods such as, for example, exponential Golomb, context-adaptive variable length coding (CAVLC), context-adaptive binary arithmetic coding (CABAC), and the like. The entropy encoder 190 may encode information necessary for video/image reconstruction other than quantized transform coefficients (e.g., values of syntax elements, etc.) together or separately. Encoded information (e.g., encoded video/image information) may be transmitted or stored in units of network abstraction layers (NALs) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. The signaled information, transmitted information and/or syntax elements described in the present disclosure may be encoded through the above-described encoding procedure and included in the bitstream.

The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 190 and/or a storage unit (not shown) storing the signal may be included as internal/external element of the image encoding apparatus 100. Alternatively, the transmitter may be provided as the component of the entropy encoder 190.

The quantized transform coefficients output from the quantizer 130 may be used to generate a residual signal. For example, the residual signal (residual block or residual samples) may be reconstructed by applying dequantization and inverse transform to the quantized transform coefficients through the dequantizer 140 and the inverse transformer 150.

The adder 155 adds the reconstructed residual signal to the prediction signal output from the inter prediction unit 180 or the intra prediction unit 185 to generate a reconstructed signal (reconstructed picture, reconstructed block, reconstructed sample array). If there is no residual for the block to be processed, such as a case where the skip mode is applied, the predicted block may be used as the reconstructed block. The adder 155 may be called a reconstructor or a reconstructed block generator. The generated reconstructed signal may be used for intra prediction of a next block to be processed in the current picture and may be used for inter prediction of a next picture through filtering as described below.

The filter 160 may improve subjective/objective image quality by applying filtering to the reconstructed signal. For example, the filter 160 may generate a modified reconstructed picture by applying various filtering methods to the reconstructed picture and store the modified reconstructed picture in the memory 170, specifically, a DPB of the memory 170. The various filtering methods may include, for example, deblocking filtering, a sample adaptive offset, an adaptive loop filter, a bilateral filter, and the like. The filter 160 may generate various information related to filtering and transmit the generated information to the entropy encoder 190 as described later in the description of each filtering method. The information related to filtering may be encoded by the entropy encoder 190 and output in the form of a bitstream.

The modified reconstructed picture transmitted to the memory 170 may be used as the reference picture in the inter prediction unit 180. When inter prediction is applied through the image encoding apparatus 100, prediction mismatch between the image encoding apparatus 100 and the image decoding apparatus may be avoided and encoding efficiency may be improved.

The DPB of the memory 170 may store the modified reconstructed picture for use as a reference picture in the inter prediction unit 180. The memory 170 may store the motion information of the block from which the motion information in the current picture is derived (or encoded) and/or the motion information of the blocks in the picture that have already been reconstructed. The stored motion information may be transmitted to the inter prediction unit 180 and used as the motion information of the spatial neighboring block or the motion information of the temporal neighboring block. The memory 170 may store reconstructed samples of reconstructed blocks in the current picture and may transfer the reconstructed samples to the intra prediction unit 185.

Overview of Image Decoding Apparatus

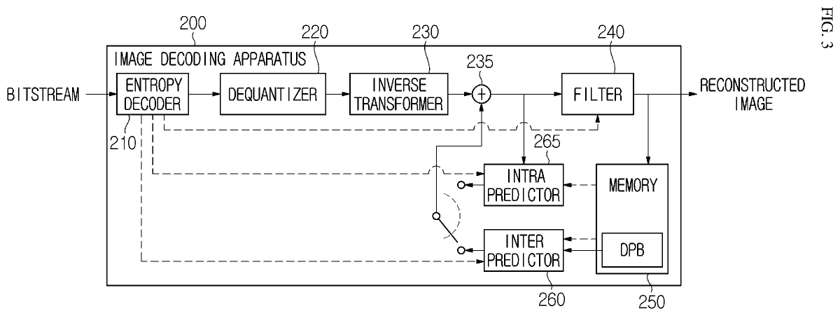

FIG. 3 is a view schematically showing an image decoding apparatus, to which an embodiment of the present disclosure is applicable.

As shown in FIG. 3, the image decoding apparatus 200 may include an entropy decoder 210, a dequantizer 220, an inverse transformer 230, an adder 235, a filter 240, a memory 250, an inter prediction unit 260 and an intra prediction unit 265. The inter prediction unit 260 and the intra prediction unit 265 may be collectively referred to as a “prediction unit”. The dequantizer 220 and the inverse transformer 230 may be included in a residual processor.

All or at least some of a plurality of components configuring the image decoding apparatus 200 may be configured by a hardware component (e.g., a decoder or a processor) according to an embodiment. In addition, the memory 250 may include a decoded picture buffer (DPB) or may be configured by a digital storage medium.

The image decoding apparatus 200, which has received a bitstream including video/image information, may reconstruct an image by performing a process corresponding to a process performed by the image encoding apparatus 100 of FIG. 2. For example, the image decoding apparatus 200 may perform decoding using a processing unit applied in the image encoding apparatus. Thus, the processing unit of decoding may be a coding unit, for example. The coding unit may be acquired by partitioning a coding tree unit or a largest coding unit. The reconstructed image signal decoded and output through the image decoding apparatus 200 may be reproduced through a reproducing apparatus (not shown).

The image decoding apparatus 200 may receive a signal output from the image encoding apparatus of FIG. 2 in the form of a bitstream. The received signal may be decoded through the entropy decoder 210. For example, the entropy decoder 210 may parse the bitstream to derive information (e.g., video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The image decoding apparatus may further decode picture based on the information on the parameter set and/or the general constraint information. Signaled/received information and/or syntax elements described in the present disclosure may be decoded through the decoding procedure and obtained from the bitstream. For example, the entropy decoder 210 decodes the information in the bitstream based on a coding method such as exponential Golomb coding, CAVLC, or CABAC, and output values of syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a neighboring block and a decoding target block or information of a symbol/bin decoded in a previous stage, and perform arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 210 may be provided to the prediction unit (the inter prediction unit 260 and the intra prediction unit 265), and the residual value on which the entropy decoding was performed in the entropy decoder 210, that is, the quantized transform coefficients and related parameter information, may be input to the dequantizer 220. In addition, information on filtering among information decoded by the entropy decoder 210 may be provided to the filter 240. Meanwhile, a receiver (not shown) for receiving a signal output from the image encoding apparatus may be further configured as an internal/external element of the image decoding apparatus 200, or the receiver may be a component of the entropy decoder 210.

Meanwhile, the image decoding apparatus according to the present disclosure may be referred to as a video/image/picture decoding apparatus. The image decoding apparatus may be classified into an information decoder (video/image/picture information decoder) and a sample decoder (video/image/picture sample decoder). The information decoder may include the entropy decoder 210. The sample decoder may include at least one of the dequantizer 220, the inverse transformer 230, the adder 235, the filter 240, the memory 250, the inter prediction unit 260 or the intra prediction unit 265.

The dequantizer 220 may dequantize the quantized transform coefficients and output the transform coefficients. The dequantizer 220 may rearrange the quantized transform coefficients in the form of a two-dimensional block. In this case, the rearrangement may be performed based on the coefficient scanning order performed in the image encoding apparatus. The dequantizer 220 may perform dequantization on the quantized transform coefficients by using a quantization parameter (e.g., quantization step size information) and obtain transform coefficients.

The inverse transformer 230 may inversely transform the transform coefficients to obtain a residual signal (residual block, residual sample array).

The prediction unit may perform prediction on the current block and generate a predicted block including prediction samples for the current block. The prediction unit may determine whether intra prediction or inter prediction is applied to the current block based on the information on the prediction output from the entropy decoder 210 and may determine a specific intra/inter prediction mode (prediction technique).

It is the same as described in the prediction unit of the image encoding apparatus 100 that the prediction unit may generate the prediction signal based on various prediction methods (techniques) which will be described later.

The intra prediction unit 265 may predict the current block by referring to the samples in the current picture. The description of the intra prediction unit 185 is equally applied to the intra prediction unit 265.

The inter prediction unit 260 may derive a predicted block for the current block based on a reference block (reference sample array) specified by a motion vector on a reference picture. In this case, in order to reduce the amount of motion information transmitted in the inter prediction mode, motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter prediction unit 260 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 235 may generate a reconstructed signal (reconstructed picture, reconstructed block, reconstructed sample array) by adding the obtained residual signal to the prediction signal (predicted block, predicted sample array) output from the prediction unit (including the inter prediction unit 260 and/or the intra prediction unit 265). If there is no residual for the block to be processed, such as when the skip mode is applied, the predicted block may be used as the reconstructed block. The description of the adder 155 is equally applicable to the adder 235. The adder 235 may be called a reconstructor or a reconstructed block generator. The generated reconstructed signal may be used for intra prediction of a next block to be processed in the current picture and may be used for inter prediction of a next picture through filtering as described below.

The filter 240 may improve subjective/objective image quality by applying filtering to the reconstructed signal. For example, the filter 240 may generate a modified reconstructed picture by applying various filtering methods to the reconstructed picture and store the modified reconstructed picture in the memory 250, specifically, a DPB of the memory 250. The various filtering methods may include, for example, deblocking filtering, a sample adaptive offset, an adaptive loop filter, a bilateral filter, and the like.

The (modified) reconstructed picture stored in the DPB of the memory 250 may be used as a reference picture in the inter prediction unit 260. The memory 250 may store the motion information of the block from which the motion information in the current picture is derived (or decoded) and/or the motion information of the blocks in the picture that have already been reconstructed. The stored motion information may be transmitted to the inter prediction unit 260 so as to be utilized as the motion information of the spatial neighboring block or the motion information of the temporal neighboring block. The memory 250 may store reconstructed samples of reconstructed blocks in the current picture and transfer the reconstructed samples to the intra prediction unit 265.

In the present disclosure, the embodiments described in the filter 160, the inter prediction unit 180, and the intra prediction unit 185 of the image encoding apparatus 100 may be equally or correspondingly applied to the filter 240, the inter prediction unit 260, and the intra prediction unit 265 of the image decoding apparatus 200.

Overview of Image Partitioning

The video/image coding method according to the present disclosure may be performed based on an image partitioning structure as follows. Specifically, the procedures of prediction, residual processing ((inverse) transform, (de)quantization, etc.), syntax element coding, and filtering, which will be described later, may be performed based on a CTU, CU (and/or TU, PU) derived based on the image partitioning structure. The image may be partitioned in block units and the block partitioning procedure may be performed in the image partitioner 110 of the encoding apparatus. The partitioning related information may be encoded by the entropy encoder 190 and transmitted to the image decoding apparatus in the form of a bitstream. The entropy decoder 210 of the image decoding apparatus may derive a block partitioning structure of the current picture based on the partitioning related information obtained from the bitstream, and based on this, may perform a series of procedures (e.g., prediction, residual processing, block/picture reconstruction, in-loop filtering, etc.) for image decoding.

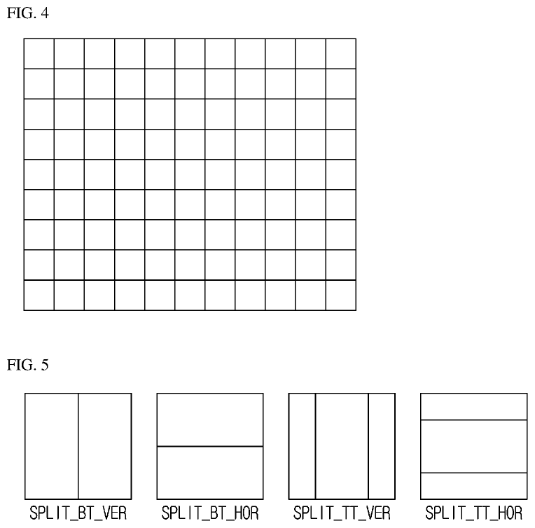

Pictures may be partitioned into a sequence of coding tree units (CTUs). FIG. 4 shows an example in which a picture is partitioned into CTUs. The CTU may correspond to a coding tree block (CTB). Alternatively, the CTU may include a coding tree block of luma samples and two coding tree blocks of corresponding chroma samples. For example, for a picture that contains three sample arrays, the CTU may include an N×N block of luma samples and two corresponding blocks of chroma samples.

Overview of Partitioning of CTU

As described above, the coding unit may be acquired by recursively partitioning the coding tree unit (CTU) or the largest coding unit (LCU) according to a quad-tree/binary-tree/ternary-tree (QT/BT/TT) structure. For example, the CTU may be first partitioned into quadtree structures. Thereafter, leaf nodes of the quadtree structure may be further partitioned by a multi-type tree structure.

Partitioning according to quadtree means that a current CU (or CTU) is partitioned into equally four. By partitioning according to quadtree, the current CU may be partitioned into four CUs having the same width and the same height. When the current CU is no longer partitioned into the quadtree structure, the current CU corresponds to the leaf node of the quad-tree structure. The CU corresponding to the leaf node of the quadtree structure may be no longer partitioned and may be used as the above-described final coding unit. Alternatively, the CU corresponding to the leaf node of the quadtree structure may be further partitioned by a multi-type tree structure.

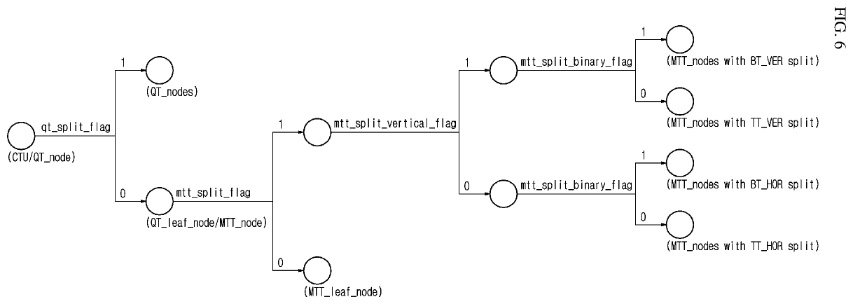

FIG. 5 is a view showing an embodiment of a splitting type of a block according to a multi-type tree structure. Splitting according to the multi-type tree structure may include two types of splitting according to a binary tree structure and two types of splitting according to a ternary tree structure.

The two types of splitting according to the binary tree structure may include vertical binary splitting (SPLIT_BT_VER) and horizontal binary splitting (SPLIT_BT_HOR). Vertical binary splitting (SPLIT_BT_VER) means that the current CU is split into equally two in the vertical direction. As shown in FIG. 4, by vertical binary splitting, two CUs having the same height as the current CU and having a width which is half the width of the current CU may be generated. Horizontal binary splitting (SPLIT_BT_HOR) means that the current CU is split into equally two in the horizontal direction. As shown in FIG. 5, by horizontal binary splitting, two CUs having a height which is half the height of the current CU and having the same width as the current CU may be generated.

Two types of splitting according to the ternary tree structure may include vertical ternary splitting (SPLIT_TT_VER) and horizontal ternary splitting (SPLIT_TT_HOR). In vertical ternary splitting (SPLIT_TT_VER), the current CU is split in the vertical direction at a ratio of 1:2:1. As shown in FIG. 5, by vertical ternary splitting, two CUs having the same height as the current CU and having a width which is ¼ of the width of the current CU and a CU having the same height as the current CU and having a width which is half the width of the current CU may be generated. In horizontal ternary splitting (SPLIT_TT_HOR), the current CU is split in the horizontal direction at a ratio of 1:2:1. As shown in FIG. 5, by horizontal ternary splitting, two CUs having a height which is ¼ of the height of the current CU and having the same width as the current CU and a CU having a height which is half the height of the current CU and having the same width as the current CU may be generated.

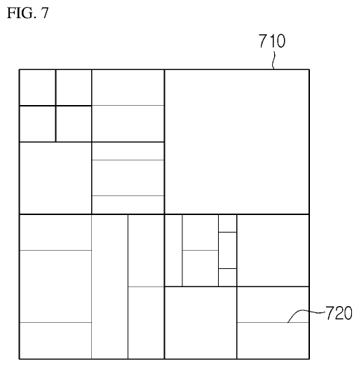

FIG. 6 is a view showing a signaling mechanism of block splitting information in a quadtree with nested multi-type tree structure according to the present disclosure.

Here, the CTU is treated as the root node of the quadtree, and is partitioned for the first time into a quadtree structure. Information (e.g., qt_split_flag) indicating whether quadtree splitting is performed with respect to the current CU (CTU or node (QT_node) of the quadtree) is signaled. For example, when qt_split_flag has a first value (e.g., “1”), the current CU may be quadtree-partitioned. In addition, when qt_split_flag has a second value (e.g., “0”), the current CU is not quadtree-partitioned, but becomes the leaf node (QT_leaf_node) of the quadtree. Each quadtree leaf node may then be further partitioned into multitype tree structures. That is, the leaf node of the quadtree may become the node (MTT_node) of the multi-type tree. In the multitype tree structure, a first flag (e.g., Mtt_split_cu_flag) is signaled to indicate whether the current node is additionally partitioned. If the corresponding node is additionally partitioned (e.g., if the first flag is 1), a second flag (e.g., Mtt_split_cu_vertical_flag) may be signaled to indicate the splitting direction. For example, the splitting direction may be a vertical direction if the second flag is 1 and may be a horizontal direction if the second flag is 0. Then, a third flag (e.g., Mtt_split_cu_binary_flag) may be signaled to indicate whether the split type is a binary split type or a ternary split type. For example, the split type may be a binary split type when the third flag is 1 and may be a ternary split type when the third flag is 0. The node of the multi-type tree acquired by binary splitting or ternary splitting may be further partitioned into multi-type tree structures. However, the node of the multi-type tree may not be partitioned into quadtree structures. If the first flag is 0, the corresponding node of the multi-type tree is no longer split but becomes the leaf node (MTT_leaf_node) of the multi-type tree. The CU corresponding to the leaf node of the multi-type tree may be used as the above-described final coding unit.

Based on the mtt_split_cu_vertical_flag and the mtt_split_cu_binary_flag, a multi-type tree splitting mode (MttSplitMode) of a CU may be derived as shown in Table 1 below. In the following description, the multi-type tree splitting mode may be referred to as a multi-tree splitting type or splitting type. In the following description, the multi-tree splitting mode may be referred to as a multi-tree splitting type or a splitting type.

TABLE 1

| MttSplitMode | mtt_split_cu_vertical_flag | mtt_split_cu_binary_flag |
|---|---|---|
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

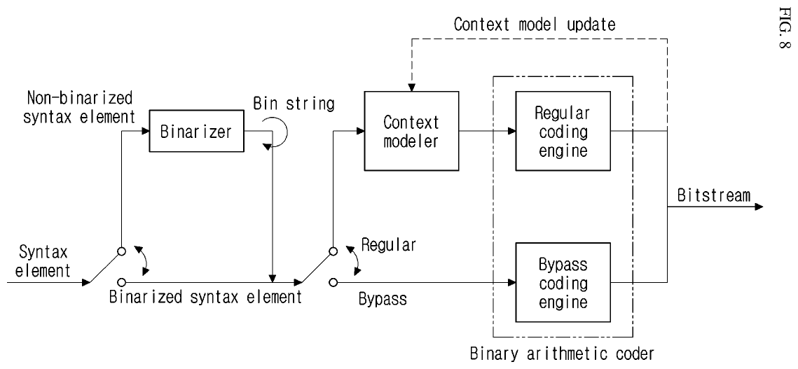

FIG. 7 is a view showing an example in which a CTU is partitioned into multiple CUs by applying a multi-type tree after applying a quadtree. In FIG. 7, bold block edges 710 represent quadtree partitioning and the remaining edges 720 represent multitype tree partitioning. The CU may correspond to a coding block (CB). In an embodiment, the CU may include a coding block of luma samples and two coding blocks of chroma samples corresponding to the luma samples. A chroma component (sample) CB or TB size may be derived based on a luma component (sample) CB or TB size according to the component ratio according to the color format (chroma format, e.g., 4:4:4, 4:2:2, 4:2:0 or the like) of the picture/image. In case of 4:4:4 color format, the chroma component CB/TB size may be set equal to be luma component CB/TB size. In case of 4:2:2 color format, the width of the chroma component CB/TB may be set to half the width of the luma component CB/TB and the height of the chroma component CB/TB may be set to the height of the luma component CB/TB. In case of 4:2:0 color format, the width of the chroma component CB/TB may be set to half the width of the luma component CB/TB and the height of the chroma component CB/TB may be set to half the height of the luma component CB/TB.

In an embodiment, when the size of the CTU is 128 based on the luma sample unit, the size of the CU may have a size from 128×128 to 4×4 which is the same size as the CTU. In one embodiment, in case of 4:2:0 color format (or chroma format), a chroma CB size may have a size from 64×64 to 2×2.

Meanwhile, in an embodiment, the CU size and the TU size may be the same. Alternatively, there may be a plurality of TUs in a CU region. The TU size generally represents a luma component (sample) transform block (TB) size.

The TU size may be derived based a largest allowable TB size maxTbSize which is a predetermined value. For example, when the CU size is greater than maxTbSize, a plurality of TUs (TBs) having maxTbSize may be derived from the CU and transform/inverse transform may be performed in units of TU (TB). For example, the largest allowable luma TB size may be 64×64 and the largest allowable chroma TB size may be 32×32. If the width or height of the CB partitioned according to the tree structure is larger than the largest transform width or height, the CB may be automatically (or implicitly) partitioned until the TB size limit in the horizontal and vertical directions is satisfied.

In addition, for example, when intra prediction is applied, an intra prediction mode/type may be derived in units of CU (or CB) and a neighboring reference sample derivation and prediction sample generation procedure may be performed in units of TU (or TB). In this case, there may be one or a plurality of TUs (or TBs) in one CU (or CB) region and, in this case, the plurality of TUs or (TBs) may share the same intra prediction mode/type.

Meanwhile, for a quadtree coding tree scheme with nested multitype tree, the following parameters may be signaled as SPS syntax elements from the image encoding apparatus to the decoding apparatus. For example, at least one of a CTU size which is a parameter representing the root node size of a quadtree, MinQTSize which is a parameter representing the minimum allowed quadtree leaf node size, MaxBtSize which is a parameter representing the maximum allowed binary tree root node size, MaxTtSize which is a parameter representing the maximum allowed ternary tree root node size, MaxMttDepth which is a parameter representing the maximum allowed hierarchy depth of multi-type tree splitting from a quadtree leaf node, MinBtSize which is a parameter representing the minimum allowed binary tree leaf node size, or MinTtSize which is a parameter representing the minimum allowed ternary tree leaf node size is signaled.

As an embodiment of using 4:2:0 chroma format, the CTU size may be set to 128×128 luma blocks and two 64×64 chroma blocks corresponding to the luma blocks. In this case, MinOTSize may be set to 16×16, MaxBtSize may be set to 128×128, MaxTtSize may be set to 64×64, MinBtSize and MinTtSize may be set to 4×4, and MaxMttDepth may be set to 4. Quadtree partitioning may be applied to the CTU to generate quadtree leaf nodes. The quadtree leaf node may be called a leaf QT node. Quadtree leaf nodes may have a size from a 16×16 size (e.g., the MinOTSize) to a 128×128 size (e.g., the CTU size). If the leaf QT node is 128×128, it may not be additionally partitioned into a binary tree/ternary tree. This is because, in this case, even if partitioned, it exceeds MaxBtsize and MaxTtsize (e.g., 64×64). In other cases, leaf QT nodes may be further partitioned into a multitype tree. Therefore, the leaf QT node is the root node for the multitype tree, and the leaf QT node may have a multitype tree depth (mttDepth) 0 value. If the multitype tree depth reaches MaxMttdepth (e.g., 4), further partitioning may not be considered further. If the width of the multitype tree node is equal to MinBtSize and less than or equal to 2×MinTtSize, then no further horizontal partitioning may be considered. If the height of the multitype tree node is equal to MinBtSize and less than or equal to 2×MinTtSize, no further vertical partitioning may be considered. When partitioning is not considered, the image encoding apparatus may skip signaling of partitioning information. In this case, the image decoding apparatus may derive partitioning information with a predetermined value.

Meanwhile, one CTU may include a coding block of luma samples (hereinafter referred to as a “luma block”) and two coding blocks of chroma samples corresponding thereto (hereinafter referred to as “chroma blocks”). The above-described coding tree scheme may be equally or separately applied to the luma block and chroma block of the current CU. Specifically, the luma and chroma blocks in one CTU may be partitioned into the same block tree structure and, in this case, the tree structure is represented as SINGLE_TREE. Alternatively, the luma and chroma blocks in one CTU may be partitioned into separate block tree structures, and, in this case, the tree structure may be represented as DUAL_TREE. That is, when the CTU is partitioned into dual trees, the block tree structure for the luma block and the block tree structure for the chroma block may be separately present. In this case, the block tree structure for the luma block may be called DUAL_TREE_LUMA, and the block tree structure for the chroma component may be called DUAL_TREE_CHROMA. For P and B slice/tile groups, luma and chroma blocks in one CTU may be limited to have the same coding tree structure. However, for I slice/tile groups, luma and chroma blocks may have a separate block tree structure from each other. If the separate block tree structure is applied, the luma CTB may be partitioned into CUs based on a particular coding tree structure, and the chroma CTB may be partitioned into chroma CUs based on another coding tree structure. That is, this means that a CU in an I slice/tile group, to which the separate block tree structure is applied, may include a coding block of luma components or coding blocks of two chroma components and a CU of a P or B slice/tile group may include blocks of three color components (a luma component and two chroma components).

Although a quadtree coding tree structure with a nested multitype tree has been described, a structure in which a CU is partitioned is not limited thereto. For example, the BT structure and the TT structure may be interpreted as a concept included in a multiple partitioning tree (MPT) structure, and the CU may be interpreted as being partitioned through the QT structure and the MPT structure. In an example where the CU is partitioned through a QT structure and an MPT structure, a syntax element (e.g., MPT_split_type) including information on how many blocks the leaf node of the QT structure is partitioned into and a syntax element (ex. MPT_split_mode) including information on which of vertical and horizontal directions the leaf node of the QT structure is partitioned into may be signaled to determine a partitioning structure.

In another example, the CU may be partitioned in a different way than the QT structure, BT structure or TT structure. That is, unlike that the CU of the lower depth is partitioned into ¼ of the CU of the higher depth according to the QT structure, the CU of the lower depth is partitioned into ½ of the CU of the higher depth according to the BT structure, or the CU of the lower depth is partitioned into ¼ or ½ of the CU of the higher depth according to the TT structure, the CU of the lower depth may be partitioned into ⅕, ⅓, ⅜, ⅗, ⅔, or ⅝ of the CU of the higher depth in some cases, and the method of partitioning the CU is not limited thereto.

The quadtree coding block structure with the multi-type tree may provide a very flexible block partitioning structure. Because of the partition types supported in a multi-type tree, different partition patterns may potentially result in the same coding block structure in some cases. In the image encoding apparatus and the decoding apparatus, by limiting the occurrence of such redundant partition patterns, a data amount of partitioning information may be reduced.

In addition, in encoding and decoding of a video/image according to the present disclosure, an image processing unit may have a hierarchical structure. One picture may be classified into one or more tiles, bricks, slices and/or tile groups. One slice may include one or more bricks. One brick may include one or more CTU rows in a tile. The slice may include an integer number of bricks of a picture. One tile group may include one or more tiles. One tile may include one or more CTUs. The CTU may be split into one or more CUs. The tile may be a rectangular region consisting of a specific tile row and a specific tile column consisting of a plurality of CTUs within a picture. The tile group may include an integer number of tiles according to tile raster scan within a picture. The slice header may carry information/parameters applicable to the corresponding slice (blocks in the slice). When an encoding apparatus or a decoding apparatus has a multi-core processor, an encoding/decoding procedure for the tile, the slice, the brick and/or the tile group may be performed in parallel.

In the present disclosure, the names or concepts of the slice or the tile group may be used interchangeably. That is, the tile group header may be called a slice header. Here, the slice may have one of slice types including an intra (I) slice, a predictive (P) slice and a bi-predictive (B) slice. For blocks in the I slice, inter prediction is not used for prediction and only intra prediction may be used. Of course, even in this case, an original sample value may be coded and signaled without prediction. For blocks in the P slice, intra prediction or inter prediction may be used, and, when inter prediction is used, only uni-prediction may be used. Meanwhile, for blocks in the B slice, intra prediction or inter prediction may be used and up to bi-prediction may be used when inter prediction is used.

The encoding apparatus may determine a tile/tile group, a brick, a slice, a maximum and minimum coding unit size according to characteristics (e.g., resolution) of a video image or in consideration of coding efficiency or parallel processing. In addition, information thereon or information capable of deriving it may be included in a bitstream.

The decoding apparatus may obtain information specifying whether a tile/tile group of a current picture, a brick, a slice and a CTU in a tile is split into a plurality of coding units. The encoding apparatus and the decoding apparatus may increase coding efficiency by signaling such information only under a specific condition.

The slice header (slice header syntax) may include information/parameters commonly applicable to the slice. APS (APS syntax) or PPS (PPS) syntax may include information/parameters commonly applicable to one or more pictures. SPS (SPS syntax) may include information/parameters commonly applicable to one or more sequences. VPS (VPS syntax) may include information/parameters commonly applicable to multiple layers. DPS (DPS syntax) may include information/parameters commonly applicable to the entire video. DPS may include information/parameters related to a combination of coded video sequences (CVSs).

In addition, for example, information on splitting and configuration of the tile/tile group/brick/slice may be constructed in the encoding stage through the higher level syntax and transmitted to the decoding apparatus in the form of a bitstream.

Quantization/Dequantization

As described above, a quantization unit of an encoding apparatus may derive quantized transform coefficients by applying quantization to transform coefficients, and a dequantization unit of an encoding apparatus or a dequantization unit of a decoding apparatus may derive transform coefficients by applying dequantization to quantized transform coefficients.

In general, in video/image encoding and decoding, a quantization rate may be changed, and a compression rate may be adjusted using the changed quantization rate. From the implementation point of view, a quantization parameter (QP) may be used instead of directly using the quantization rate in consideration of complexity. For example, a quantization parameter of an integer value from 0 to 63 may be used, and the value of each quantization parameter may correspond to an actual quantization rate. A quantization parameter QP_{Y} for a luma component (luma sample) and a quantization parameter QP_{C} for a chroma component (chroma sample) may be differently set.

In a quantization process, a transform coefficient C may be received as input and divided by quantization rate Qstep, thereby deriving a quantized transform coefficient C′. In this case, in consideration of computational complexity, the quantization rate is multiplied by a scale to form an integer and shift operation may be performed by a value corresponding to the scale value. Based on the product of the quantization rate and the scale value, a quantization scale may be derived. That is, the quantization scale may be derived according to QP. By applying the quantization scale to the transform coefficient C, the quantized transform coefficient C′ may be derived based on this.

A dequantization process is an inverse process of the quantization process, and the quantized transform coefficient C′ may be multiplied by the quantization rate Qstep, thereby obtaining a reconstructed transform coefficient C″. In this case, a level scale may be derived according to the quantization parameter and the level scale may be applied to the quantized transform coefficient C′, thereby deriving a reconstructed transform coefficient C″. The reconstructed transform coefficient C″ may be slightly different from the original transform coefficient C due to loss in the transform and/or quantization process. Accordingly, even the encoding apparatus may perform dequantization in the same manner as the decoding apparatus.

Meanwhile, adaptive frequency weighting quantization technology of adjusting a quantization strength according to frequency may apply. The adaptive frequency weighting quantization technology is a method of differently applying a quantization strength according to the frequency. In adaptive frequency weighting quantization, the quantization strength may differently apply according to the frequency using a predefined quantization scaling matrix. That is, the above-described quantization/dequantization process may be performed further based on the quantization scaling matrix. For example, a different quantization scaling matrix may be used according to a size of a current block and/or whether a prediction mode applying to the current block in order to generate a residual signal of the current block is inter prediction or intra prediction. The quantization scaling matrix may also be referred to as a quantization matrix or a scaling matrix. The quantization scaling matrix may be predefined. In addition, frequency quantization scale information for the quantization scaling matrix for frequency adaptive scaling may be constructed/encoded by the encoding apparatus and signaled to the decoding apparatus. The frequency quantization scale information may be referred to as quantization scaling information. The frequency quantization scale information may include scaling list data scaling_list_data. Based on the scaling list data, the (modified) quantization scaling matrix may be derived. In addition, the frequency quantization scale information may include present flag information specifying whether the scaling list data is present. Alternatively, when the scaling list data is signaled at a higher level (e.g., SPS), information specifying whether the scaling list data is modified at a lower level (e.g., PPS or tile group header, etc.) may be further included.

Entropy Coding

All or some of video/image information may be entropy-encoded by the entropy encoder 190 as described above with reference to FIG. 2, and all or some of the video/image information described with reference to FIG. 3 may be entropy-decoded by the entropy decoder 310. In this case, the video/image information may be encoded/decoded in units of a syntax element. In the present disclosure, encoding/decoding information may include encoding/decoding by the method described in this paragraph.

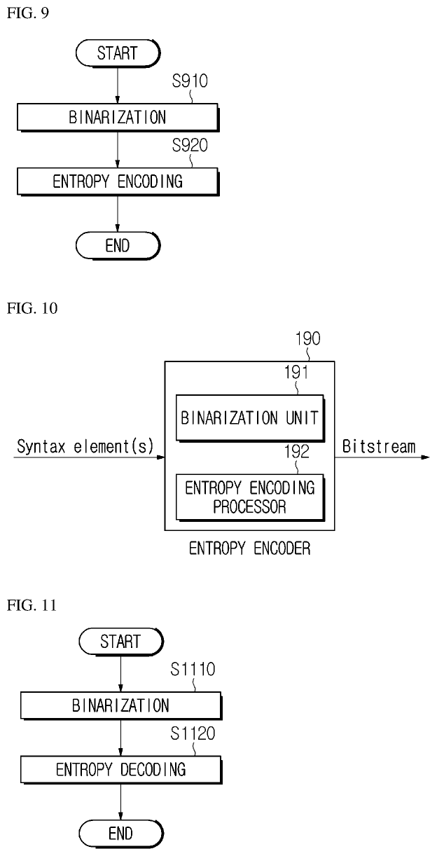

FIG. 8 is a block diagram of a CABAC for encoding one syntax element. In the encoding process of CABAC, first, when an input signal is a syntax element other than a binary value, the input signal may be transformed into a binary value through binarization. When the input signal already has a binary value, binarization may be bypassed. Here, a binary number 0 or 1 configuring a binary value may be referred to as a bin. For example, when a binary string (bin string) after binarization is 110, each of 1, 1 and 0 may be referred to as one bin. The bin(s) for one syntax element may represent the value of a corresponding syntax element.

The binarized bins may be input to a regular coding engine or a bypass coding engine. The regular coding engine may allocate a context model reflecting a probability value to a corresponding bin and encode the corresponding bit based on the allocated context model. The regular coding engine may code each bin and then update a probability model for the corresponding bin. The bins coded in this way may be referred to as context-coded bins. The bypass coding engine may bypass a procedure for estimating a probability with respect to an input bin and a procedure for updating a probability mode applied to a corresponding bin after coding. The bypass coding engine may code an input bin by applying a uniform probability distribution (e.g., 50:50) instead of allocating a context, thereby improving a coding speed. Bins coded in this way may be referred to as a bypass bin. A context model may be allocated and updated for each context-coded (regularly coded) bin, and the context model may be indicated based on ctxidx or ctxInc. ctxidx may be derived based on ctxInc. Specifically, for example, a context index ctxidx indicating the context model for each of the regularly coded bins may be derived as a sum of a context index increment (ctxInc) and a context index offset (ctxIdxOffset). Here, ctxInc may be differently derived for each bin. ctxIdxOffset may be represented by a lowest value of ctxIdx. The lowest value of ctxIdx may be referred to as an initial value initValue of ctxIdx. ctxIdxOffset is generally a value used to be distinguished from context models for other syntax elements, and a context model for one syntax element may be distinguished/derived based on ctxinc.

In the entropy encoding procedure, whether encoding is performed through the regular coding engine or the bypass coding engine may be determined and a coding path may be switched. Entropy decoding may be performed in the reverse order of the same process as entropy encoding.

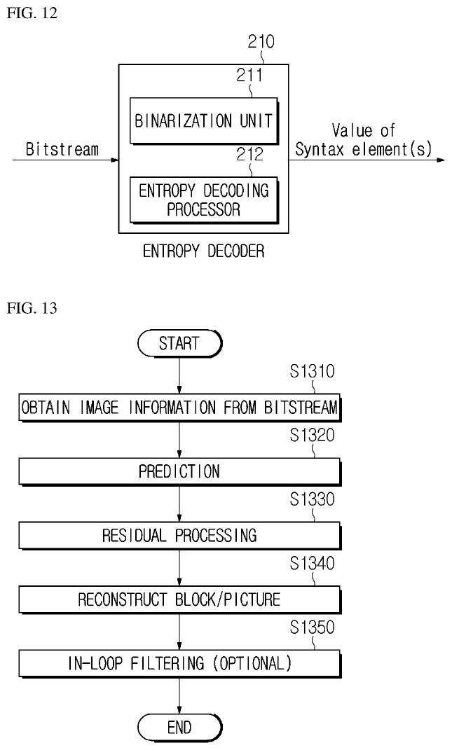

The above-described entropy coding may be performed, for example, as shown in FIGS. 9 and 10. Referring to FIGS. 9 and 10, the encoding apparatus (entropy encoder) may perform an entropy coding procedure for image/video information. The image/video information may include partitioning related information, prediction related information (e.g., inter/intra prediction distinction information, intra prediction mode information, inter prediction mode information, etc.), residual information, in-loop filtering related information, etc. or may include various syntax elements related thereto. Entropy coding may be performed in units of a syntax element. Steps S910 to S920 of FIG. 9 may be performed by the entropy encoder 190 of the encoding apparatus of FIG. 2.

The encoding apparatus may perform binarization with respect to a target syntax element (S910). Here, binarization may be based on various binarization methods such as a Truncated Rice binarization process, Fixed-length binarization process, etc., and the binarization method for the target syntax element may be predefined. The binarization procedure may be performed by a binarization unit 191 in the entropy encoder 190.

The encoding apparatus may entropy encoding with respect to the target syntax element (S920). The encoding apparatus may perform regular coding based (context based) or bypass coding based encoding with respect to a bin string of the target syntax element based on an entropy coding technique such as CABAC (context-adaptive arithmetic coding) or CAVLC (context-adaptive variable length coding), and the output thereof may be included in a bitstream. The entropy encoding procedure may be performed by an entropy encoding processor 192 in the entropy encoder 190. As described above, the bitstream may be transmitted to the decoding apparatus through a (digital) storage medium or a network.

Referring to FIGS. 11 and 12, the decoding apparatus (entropy decoder) may decode encoded image/video information. The image/video information may include partitioning related information, prediction related information (e.g., inter/intra prediction distinction information, intra prediction mode information, inter prediction mode information, etc.), residual information, in-loop filtering related information, etc. or may include various syntax elements related thereto. Entropy coding may be performed in units of a syntax element. Steps S1110 to S1120 may be performed by the entropy decoder 210 of the decoding apparatus of FIG. 3.

The decoding apparatus may perform binarization with respect to a target syntax element (S1110). Here, binarization may be based on various binarization methods such as a Truncated Rice binarization process, Fixed-length binarization process, etc., and the binarization method for the target syntax element may be predefined. The decoding apparatus may derive available bin strings (bin string candidates) for available values of the target syntax element through the binarization procedure. The binarization procedure may be performed by a binarization unit 211 in the entropy decoder 210.

The decoding apparatus may perform entropy decoding with respect to the target syntax element (S1120). The decoding apparatus may compare the derived bin string with available bin strings for a corresponding syntax element, while sequentially decoding and parsing the bins for the target syntax element from input bit(s) in the bitstream. If the derived bin string is equal to one of the available bin strings, a value corresponding to the corresponding bin string may be derived as a value of the corresponding syntax element. If not, the above-described procedure may be performed again after a next bit in the bitstream is further parsed. Through such a process, corresponding information may be signaled using a variable length bit without using a start or end bit for specific information (specific syntax element) in the bitstream. Through this, a relatively fewer bits may be allocated to a low value and overall coding efficiency may be improved.

The decoding apparatus may perform context based or bypass based decoding with respect to the bins in the bin string from the bitstream based on an entropy coding technique such as CABAC or CAVLC. The entropy decoding procedure may be performed by an entropy decoding processor 212 in the entropy decoder 210. The bitstream may include a variety of information for image/video decoding as described above. As described above, the bitstream may be transmitted to the decoding apparatus through a (digital) storage medium or a network.

In the present disclosure, a table (syntax table) including syntax elements may be used to indicate signaling of information from the encoding apparatus to the decoding apparatus. The order of the syntax elements of the table including the syntax elements used in the present disclosure may indicate the parsing order of the syntax elements from the bitstream. The encoding apparatus may construct and encode the syntax element such that the decoding apparatus parses the syntax element in the parsing order, and the decoding apparatus may parse and decode the syntax elements of the corresponding syntax table from the bitstream according to the parsing order and obtain the values of the syntax elements.

General Image/Video Coding Procedure

In image/video coding, a picture configuring an image/video may be encoded/decoded according to a decoding order. A picture order corresponding to an output order of the decoded picture may be set differently from the decoding order, and, based on this, not only forward prediction but also backward prediction may be performed during inter prediction.

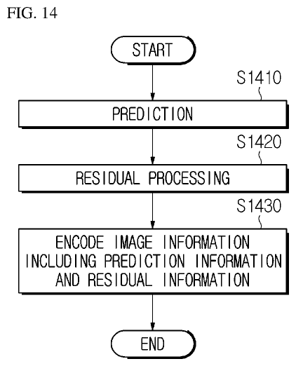

FIG. 13 shows an example of a schematic picture decoding procedure, to which embodiment(s) of the present disclosure is applicable. In FIG. 13, S1310 may be performed in the entropy decoder 210 of the decoding apparatus, S1320 may be performed in a prediction unit including the intra prediction unit 265 and the inter prediction unit 260, S1330 may be performed in a residual processor including the dequantizer 220 and the inverse transformer 230, S1340 may be performed in the adder 235, and S1350 may be performed in the filter 240. S1310 may include the information decoding procedure described in the present disclosure, S1320 may include the inter/intra prediction procedure described in the present disclosure, S1330 may include a residual processing procedure described in the present disclosure, S1340 may include the block/picture reconstruction procedure described in the present disclosure, and S1350 may include the in-loop filtering procedure described in the present disclosure.

Referring to FIG. 13, the picture decoding procedure may schematically include a procedure (S1310) for obtaining image/video information (through decoding) from a bitstream, a picture reconstruction procedure (S1320 to S1340) and an in-loop filtering procedure (S1350) for a reconstructed picture. The picture reconstruction procedure may be performed based on prediction samples and residual samples obtained through inter/intra prediction (S1320) and residual processing (S1330) (dequantization and inverse transform of the quantized transform coefficient) described in the present disclosure. A modified reconstructed picture may be generated through the in-loop filtering procedure for the reconstructed picture generated through the picture reconstruction procedure, the modified reconstructed picture may be output as a decoded picture, stored in a decoded picture buffer or memory 250 of the decoding apparatus and used as a reference picture in the inter prediction procedure when decoding the picture later. In some cases, the in-loop filtering procedure may be omitted. In this case, the reconstructed picture may be output as a decoded picture, stored in a decoded picture buffer or memory 250 of the decoding apparatus, and used as a reference picture in the inter prediction procedure when decoding the picture later. The in-loop filtering procedure (S1350) may include a deblocking filtering procedure, a sample adaptive offset (SAO) procedure, an adaptive loop filter (ALF) procedure and/or a bi-lateral filter procedure, as described above, some or all of which may be omitted. In addition, one or some of the deblocking filtering procedure, the sample adaptive offset (SAO) procedure, the adaptive loop filter (ALF) procedure and/or the bi-lateral filter procedure may be sequentially applied or all of them may be sequentially applied. For example, after the deblocking filtering procedure is applied to the reconstructed picture, the SAO procedure may be performed. Alternatively, for example, after the deblocking filtering procedure is applied to the reconstructed picture, the ALF procedure may be performed. This may be similarly performed even in the encoding apparatus.

FIG. 14 shows an example of a schematic picture encoding procedure, to which embodiment(s) of the present disclosure is applicable. In FIG. 14, S1410 may be performed in the prediction unit including the intra prediction unit 185 or inter prediction unit 180 of the encoding apparatus described above with reference to FIG. 2, S1420 may be performed in a residual processor including the transformer 120 and/or the quantizer 130, and S1430 may be performed in the entropy encoder 190. S1410 may include the inter/intra prediction procedure described in the present disclosure, S1420 may include the residual processing procedure described in the present disclosure, and S1430 may include the information encoding procedure described in the present disclosure.

Referring to FIG. 14, the picture encoding procedure may schematically include not only a procedure for encoding and outputting information for picture reconstruction (e.g., prediction information, residual information, partitioning information, etc.) in the form of a bitstream but also a procedure for generating a reconstructed picture for a current picture and a procedure (optional) for applying in-loop filtering to a reconstructed picture, as described with respect to FIG. 2. The encoding apparatus may derive (modified) residual samples from a quantized transform coefficient through the dequantizer 140 and the inverse transformer 150, and generate the reconstructed picture based on the prediction samples which are output of S1410 and the (modified) residual samples. The reconstructed picture generated in this way may be equal to the reconstructed picture generated in the decoding apparatus. The modified reconstructed picture may be generated through the in-loop filtering procedure for the reconstructed picture, may be stored in the decoded picture buffer or memory 170, and may be used as a reference picture in the inter prediction procedure when encoding the picture later, similarly to the decoding apparatus. As described above, in some cases, some or all of the in-loop filtering procedure may be omitted. When the in-loop filtering procedure is performed, (in-loop) filtering related information (parameter) may be encoded in the entropy encoder 190 and output in the form of a bitstream, and the decoding apparatus may perform the in-loop filtering procedure using the same method as the encoding apparatus based on the filtering related information.

Through such an in-loop filtering procedure, noise occurring during image/video coding, such as blocking artifact and ringing artifact, may be reduced and subjective/objective visual quality may be improved. In addition, by performing the in-loop filtering procedure in both the encoding apparatus and the decoding apparatus, the encoding apparatus and the decoding apparatus may derive the same prediction result, picture coding reliability may be increased and the amount of data to be transmitted for picture coding may be reduced.

As described above, the picture reconstruction procedure may be performed not only in the decoding apparatus but also in the encoding apparatus. A reconstructed block may be generated based on intra prediction/inter prediction in units of blocks, and a reconstructed picture including reconstructed blocks may be generated. When a current picture/slice/tile group is an I picture/slice/tile group, blocks included in the current picture/slice/tile group may be reconstructed based on only intra prediction. Meanwhile, when the current picture/slice/tile group is a P or B picture/slice/tile group, blocks included in the current picture/slice/tile group may be reconstructed based on intra prediction or inter prediction. In this case, inter prediction may be applied to some blocks in the current picture/slice/tile group and intra prediction may be applied to the remaining blocks. The color component of the picture may include a luma component and a chroma component and the methods and embodiments of the present disclosure are applicable to the luma component and the chroma component unless explicitly limited in the present disclosure.

Example of Coding Layer and Structure

A coded video/image according to the present disclosure may be processed, for example, according to a coding layer and structure which will be described below.

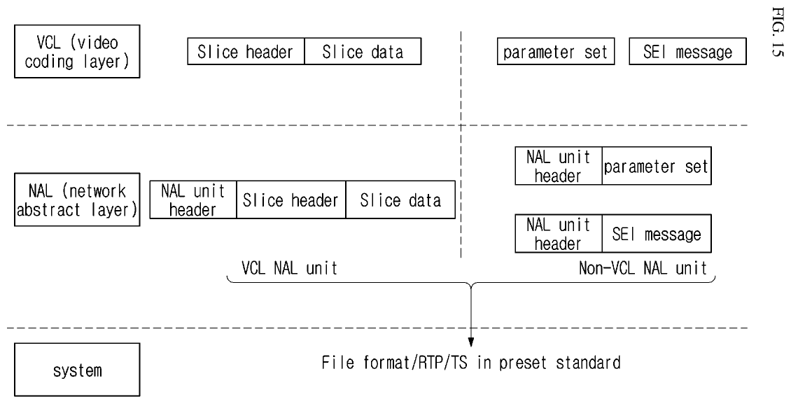

FIG. 15 is a view showing a hierarchical structure for a coded image. The coded image may be classified into a video coding layer (VCL) for an image decoding process and handling itself, a lower system for transmitting and storing encoded information, and a network abstraction layer (NAL) present between the VCL and the lower system and responsible for a network adaptation function.

In the VCL, VCL data including compressed image data (slice data) may be generated or a supplemental enhancement information (SEI) message additionally required for a decoding process of an image or a parameter set including information such as a picture parameter set (PPS), a sequence parameter set (SPS) or a video parameter set (VPS) may be generated.

In the NAL, header information (NAL unit header) may be added to a raw byte sequence payload (RBSP) generated in the VCL to generate an NAL unit. In this case, the RBSP refers to slice data, a parameter set, an SEI message generated in the VCL. The NAL unit header may include NAL unit type information specified according to RBSP data included in a corresponding NAL unit.

As shown in the figure, the NAL unit may be classified into a VCL NAL unit and a non-VCL NAL unit according to the RBSP generated in the VCL. The VCL NAL unit may mean a NAL unit including information on an image (slice data), and the Non-VCL NAL unit may mean a NAL unit including information (parameter set or SEI message) required to decode an image.

The VCL NAL unit and the Non-VCL NAL unit may be attached with header information and transmitted through a network according to the data standard of the lower system. For example, the NAL unit may be modified into a data format of a predetermined standard, such as H.266/VVC file format, RTP (Real-time Transport Protocol) or TS (Transport Stream), and transmitted through various networks.

As described above, in the NAL unit, a NAL unit type may be specified according to the RBSP data structure included in the corresponding NAL unit, and information on the NAL unit type may be stored in a NAL unit header and signaled.

For example, this may be largely classified into a VCL NAL unit type and a non-VCL NAL unit type depending on whether the NAL unit includes information on an image (slice data). The VCL NAL unit type may be classified according to the property and type of the picture included in the VCL NAL unit, and the Non-VCL NAL unit type may be classified according to the type of a parameter set.

An example of the NAL unit type specified according to the type of the parameter set included in the Non-VCL NAL unit type will be listed below.
APS (Adaptation Parameter Set) NAL unit: Type for NAL unit including APS

DPS (Decoding Parameter Set) NAL unit: Type for NAL unit including DPS
VPS (Video Parameter Set) NAL unit: Type for NAL unit including VPS
SPS (Sequence Parameter Set) NAL unit: Type for NAL unit including SPS
PPS (Picture Parameter Set) NAL unit: Type for NAL unit including PPS

The above-described NAL unit types may have syntax information for a NAL unit type, and the syntax information may be stored in a NAL unit header and signaled. For example, the syntax information may be nal_unit_type, and the NAL unit types may be specified as nal_unit_type values.

The slice header (slice header syntax) may include information/parameters commonly applicable to the slice. The APS (APS syntax) or PPS (PPS syntax) may include information/parameters commonly applicable to one or more slices or pictures. The SPS (SPS syntax) may include information/parameters commonly applicable to one or more sequences. The VPS (VPS syntax) may information/parameters commonly applicable to multiple layers. The DPS (DPS syntax) may include information/parameters commonly applicable to an overall video. The DPS may include information/parameters related to concatenation of a coded video sequence (CVS). In the present disclosure, a high level syntax (HLS) may include at least one of the APS syntax, the PPS syntax, the SPS syntax, the VPS syntax, the DPS syntax or the slice header syntax.

In the present disclosure, image/video information encoded in the encoding apparatus and signaled to the decoding apparatus in the form of a bitstream may include not only in-picture partitioning related information, intra/inter prediction information, residual information, in-loop filtering information but also information included in the slice header, information included in the APS, information included in the PPS, information included in the SPS, and/or information included in the VPS.

Overview of Intra Prediction

Hereinafter, intra prediction performed by the encoding and decoding apparatus described above will be described in greater detail. Intra prediction may represent prediction for generating prediction samples for a current block based on reference samples in a picture to which a current block belongs (hereinafter referred to as a current picture).

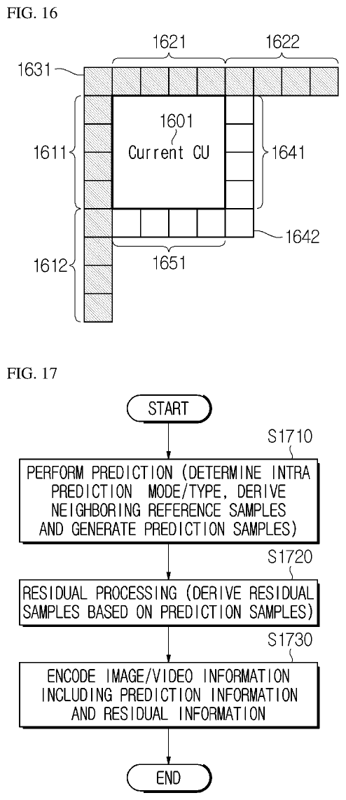

A description will be given with reference to FIG. 16. When intra prediction is applied to a current block 1601, neighboring reference samples to be used for intra prediction of the current block 1601 may be derived. The neighboring reference samples of the current block may include a total of 2×nh samples including samples 1611 adjacent to a left boundary of the current block having a size of nW×nH and samples 1612 adjacent to a bottom-left, a total of 2×nW samples including samples 1621 adjacent to a top boundary of the current block and samples 1622 adjacent to a top-right, and one sample 1631 adjacent to a top-left of the current block. Alternatively, the neighboring reference samples of the current block may include a plurality of columns of top neighboring samples and a plurality of rows of left neighboring samples.

In addition, the neighboring reference samples of the current block may include a total of nH samples 1641 adjacent to a right boundary of the current block having a size of nW×nH, a total of nW samples 1651 adjacent to a bottom boundary of the current block and one sample 1642 adjacent to a bottom-right of the current block.

However, some of the neighboring reference samples of the current block have not yet been decoded or may not be available. In this case, the decoding apparatus may construct neighboring reference samples to be used for prediction by substituting unavailable samples with available samples. Alternatively, neighboring reference samples to be used for prediction may be constructed through interpolation of available samples.

When neighboring reference samples are derived, (i) a prediction sample may be derived based on an average or interpolation of neighboring reference samples of the current block and (ii) the prediction sample may be derived based on a reference sample present in a specific (prediction) direction with respect to the prediction sample among the neighboring reference samples of the current block. The case of (i) may be referred to as a non-directional mode or a non-angular mode and the case of (ii) may be referred to as a directional mode or an angular mode. In addition, the prediction sample may be generated through interpolation between a first neighboring sample and a second neighboring sample located in a direction opposite to a prediction direction of an intra prediction mode of the current block based on the prediction sample of the current block among the neighboring reference samples. The above-described case may be referred to as a linear interpolation intra prediction (LIP). In addition, chroma prediction samples may be generated based on luma samples using a linear model. This case may be called an LM mode. In addition, a temporary prediction sample of the current block may be derived based on filtered neighboring reference samples, and the prediction sample of the current block may be derived by weighted-summing the temporary prediction sample and at least one reference sample derived according to the intra prediction mode among existing neighboring reference samples, that is, unfiltered neighboring reference samples. The above-described case may be called position dependent intra prediction (PDPC). In addition, a reference sample line with highest prediction accuracy may be selected from among multiple neighboring reference sample lines of the current block and the prediction sample may be derived using a reference sample located in a prediction direction on a corresponding line. At this time, intra prediction encoding may be performed by instructing (signaling) a used reference sample line to the decoding apparatus. The above-described case may be called multi-reference line (MRL) intra prediction or MRL based intra prediction. In addition, the current block may be partitioned into vertical or horizontal subpartitions, intra prediction may be performed based on the same intra prediction mode, and neighboring reference samples may be derived and used in units of subpartitions. That is, in this case, the intra prediction mode for the current block is equally applied to the subpartitions, and neighboring reference samples may be derived and used in units of subpartitions, thereby increasing intra prediction performance in some cases. Such a prediction method may be called intra sub-partitions (ISP) or ISP based intra prediction. Such intra prediction methods may be called an intra prediction type, in order to be distinguished from an intra prediction mode (e.g., DC mode, Planar mode or directional mode). The intra prediction type may be called various terms such as an intra prediction technique or an additional intra prediction mode. For example, the intra prediction type (or the additional intra prediction mode, etc.) may include at least one of the above-described LIP, PDPC, MRL, and ISP. A normal intra prediction method excluding specific intra prediction types such as LIP, PDPC, MRL and ISP may be called a normal intra prediction type. The normal intra prediction type may refer to a case where the specific intra prediction type is not applied, and prediction may be performed based on the above-described intra prediction mode. Meanwhile, post-filtering may be performed with respect to the derived prediction sample as necessary.

Specifically, an intra prediction procedure may include an intra prediction mode/type determination step, a neighboring reference sample derivation step and an intra prediction mode/type based prediction sample derivation step. In addition, post-filtering may be performed with respect to the derived prediction sample as necessary.

Meanwhile, in addition to the above-described intra prediction types, affine linear weighted intra prediction (ALWIP) may be used. ALWIP may be called linear weighted intra prediction (LWIP), matrix weighted intra prediction (MIP) or matrix based intra prediction. When MIP is applied to the current block, i) using neighboring reference samples subjected to an averaging procedure, ii) a matrix-vector-multiplication procedure may be performed and iii) a horizontal/vertical interpolation procedure may be further performed as necessary, thereby deriving the prediction samples for the current block. Intra prediction modes used for MIP may be constructed differently from intra prediction modes used in the above-described LIP, PDPC, MRL, ISP intra prediction or normal intra prediction. The intra prediction mode for MIP may be called a MIP intra prediction mode, a MIP prediction mode or a MIP mode. For example, a matrix and offset used in matrix-vector-multiplication may be differently set according to the intra prediction mode for MIP. Here, the matrix may be referred to as a (MIP) weight matrix, and the offset may be referred to as a (MIP) offset vector or a (MIP) bias vector. A detailed MIP method will be described below.

A block reconstruction procedure based on intra prediction and an intra prediction unit in the encoding apparatus may schematically include, for example, the following. S1710 may be performed by the intra prediction unit 185 of the encoding apparatus, and S1720 may be performed by a residual processor including at least one of the subtractor 115, the transformer 120, the quantizer 130, the dequantizer 140 and the inverse transformer 150 of the encoding apparatus. Specifically, S1720 may be performed by the subtractor 115 of the encoding apparatus. In S1730, prediction information may be derived by the intra prediction unit 185, and may be encoded by the entropy encoder 190. In S1730, residual information may be derived by a residual processor, and may be encoded by the entropy encoder 190. The residual information is information on residual samples. The residual information may include information on quantized transform coefficients for the residual samples. As described above, the residual samples may be derived as transform coefficients through the transformer 120 of the encoding apparatus, and the transform coefficients may be derived as quantized transform coefficients through the quantizer 130. Information on the quantized transform coefficients may be encoded by the entropy encoder 190 through a residual coding procedure.

The encoding apparatus may perform intra prediction with respect to the current block (S1710). The encoding apparatus may derive an intra prediction mode/type for the current block, derive neighboring reference samples of the current block, and generate prediction samples in the current block based on the intra prediction mode/type and the neighboring reference samples. Here, a procedure for determining an intra prediction mode/type, a procedure for deriving neighboring reference samples and a procedure for generating prediction samples may be simultaneously performed, or any one procedure may be performed before another procedure. For example, although not shown, the intra prediction unit 185 of the encoding apparatus may include an intra prediction mode/type determination unit, a reference sample derivation unit, a prediction sample derivation unit. The intra prediction mode/type determination unit may determine the intra prediction mode/type for the current block, the reference sample derivation unit may derive neighboring reference samples of the current block, and the prediction sample derivation unit may derive the prediction samples of the current block. Meanwhile, when the below-described prediction sample filtering procedure is performed, the intra prediction unit 185 may further include a prediction sample filter. The encoding apparatus may determine a mode/type applied to the current block from among a plurality of intra prediction modes/types. The encoding apparatus may compare RD costs of the intra prediction modes/types and determine an optimal intra prediction mode/type for the current block.

Meanwhile, the encoding apparatus may perform a prediction sample filtering procedure. Prediction sample filtering may be referred to as post-filtering. Some or all of the prediction samples may be filtered by the prediction sample filtering procedure. In some cases, the prediction sample filtering procedure may be omitted.

The encoding apparatus may generate residual samples for the current block based on (filtered) prediction samples (S1720). The encoding apparatus may compare the prediction samples from the original samples of the current block based on a phase and derive the residual samples.

The encoding apparatus may encode image information including information on intra prediction (prediction information) and residual information of the residual samples (S1730). The prediction information may include the intra prediction mode information and the intra prediction type information. The encoding apparatus may output encoded image information in the form of a bitstream. The output bitstream may be transmitted to the decoding apparatus through a storage medium or a network.

The residual information may include a residual coding syntax described below. The encoding apparatus may transform/quantize the residual samples to derive quantized transform coefficients. The residual information may include information on the quantized transform coefficients.

Meanwhile, as described above, the encoding apparatus may generate a reconstructed picture (including reconstructed samples and a reconstructed block). To this end, the encoding apparatus may perform dequantization/inverse transform with respect to the quantized transform coefficients again to derive (modified) residual samples. The residual samples are transformed/quantized and then dequantized/inversely transformed in order to derive the same residual samples as the residual samples derived in the decoding apparatus as described above. The encoding apparatus may generate a reconstructed block including the reconstructed samples for the current block based on the prediction samples and the (modified) residual samples. A reconstructed picture for the current picture may be generated based on the reconstructed block. As described above, an in-loop filtering procedure is further applicable to the reconstructed picture.

The video/image decoding procedure based on intra prediction and the intra prediction unit in the decoding apparatus may schematically include the following, for example. The decoding apparatus may perform operation corresponding to operation performed in the encoding apparatus.

S1810 to S1830 may be performed by the intra prediction unit 265 of the decoding apparatus, and the prediction information of S1810 and the residual information of S1840 may be obtained from the bitstream by the entropy decoder 210 of the decoding apparatus. The residual processor including at least one of the dequantizer 220 and the inverse transformer 230 of the decoding apparatus may derive the residual samples for the current block based on the residual information. Specifically, the dequantizer 220 of the residual processor may perform dequantization based on quantized transform coefficients derived based on the residual information to derive transform coefficients and the dequantizer 220 of the residual processor may perform inverse transform with respect to the transform coefficients to derive the residual samples for the current block. S1850 may be performed by the adder 235 or the reconstructor of the decoding apparatus.

Specifically, the decoding apparatus may derive a intra prediction mode/type for the current block based on the received prediction information (intra prediction mode/type information) (S1810). The decoding apparatus may derive neighboring reference samples of the current block (S1820). The decoding apparatus may generate prediction samples in the current blocks based on the intra prediction mode/type and the neighboring reference samples (S1830). In this case, the decoding apparatus may perform a prediction sample filtering procedure. Prediction sample filtering may be referred to as post-filtering. Some or all of the prediction samples may be filtered by the prediction sample filtering procedure. In some cases, the prediction sample filtering procedure may be omitted.

The decoding apparatus may generate residual samples for the current block based on the received residual information. The decoding apparatus may generate reconstructed samples for the current block based on the prediction samples and the residual samples, and derive a reconstruction sample including the reconstructed samples (S1840). A reconstructed picture for the current picture may be generated based on the reconstructed block. As described above, the in-loop filtering procedure is further applicable to the reconstructed picture.

Here, although not shown, the intra prediction unit 265 of the decoding apparatus may include an intra prediction mode/type determination unit, a reference sample derivation unit and a prediction sample derivation unit, the intra prediction mode/type determination unit may determine the intra prediction mode/type for the current block based on the intra prediction mode/type information acquired by the entropy decoder 210, the reference sample derivation unit may derive the neighboring reference samples of the current block, and the prediction sample derivation unit may derive the prediction samples of the current block. Meanwhile, when the above-described prediction sample filtering procedure is performed, the intra prediction unit 265 may further include a prediction sample filter.

The intra prediction mode information may include flag information (e.g., intra_luma_mpm_flag) indicating whether a most probable mode (MPM) or a remaining mode is applied to the current block, and, when the MPM is applied to the current block, the prediction mode information may further include index information (e.g., intra_luma_mpm_idx) indicating one of intra prediction mode candidates (MPM candidates). The intra prediction mode candidates (MPM candidates) may be configured as an MPM candidate list or an MPM list. In addition, when the MPM is not applied to the current block, the intra prediction mode information may further include remaining mode information (e.g., intra_luma_mpm_remainder) indicating one of the remaining intra prediction modes excluding the intra prediction mode candidates (MPM candidates). The decoding apparatus may determine the intra prediction mode of the current block based on the intra prediction mode information. A separate MPM list may be configured for the above-described MIP.

In addition, the intra prediction type information may be implemented in various forms. For example, the intra prediction type information may include intra prediction type index information indicating one of the intra prediction types. As another example, the intra prediction type information may include at least one of reference sample line information (e.g., intra_luma_ref idx)) indicating whether the MRL is applied to the current block and which reference sample line is used if applied, ISP flag information (e.g., intra_subpartitions_mode_flag) indicating whether the ISP is applied to the current block, ISP type information (e.g., intra_subpartitions_split_flag) indicating the split type of subpartitions when the ISP is applied, flag information indicating whether PDCP is applied or flag information indicating whether LIP is applied. In addition, the intra prediction type information may include an MIP flag indicating whether MIP is applied to the current block.

The intra prediction mode information and/or the intra prediction type information may be encoded/decoded through the coding method described in the present disclosure. For example, the intra prediction mode information and/or the intra prediction type information may be encoded/decoded through entropy coding (e.g., CABAC or CAVLC) based on truncated (rice) binary code.

Intra Prediction Mode/Type Determination

When applying intra prediction, an intra prediction mode applying to a current block may be determined using an intra prediction mode of a neighboring block. For example, the decoding apparatus may select, based on a received mpm index, one of mpm candidates in a most probable mode (mpm) derived based on intra prediction modes of neighboring blocks (e.g., left and/or top neighboring blocks) of a current block and additional candidate modes or select one of remaining intra prediction modes not included in the mpm candidates (and the planar mode) based on remaining intra prediction mode information.

The mpm list may be constructed to or not to include the planar mode as a candidate. For example, when the mpm list includes the planar mode as a candidate, the mpm list may have six candidates and, when the mpm list does not include the planar mode as a candidate, the mpm list may have three candidates. When the mpm list does not include the planar mode as a candidate, a not planar flag (e.g., intra_luma_not_planar_flag) specifying whether the intra prediction mode of the current block is not a planar mode may be signaled. For example, the mpm flag may be first signaled and the mpm index and the not planar flag may be signaled when the value of the mpm flag is 1. In addition, the mpm index may be signaled when the value of the not planar flag is 1. Here, the mpm list is constructed not to include the planar mode, in order to first determine whether it is a planar mode by first signaling a flag (not planar flag), because the planar mode is always considered as mpm, rather than the planar mode being not mpm.

For example, whether the intra prediction mode applying to the current block is in mpm candidates (and the planar mode) or in remaining modes may be specified based on an mpm flag (e.g., intra_luma_mpm_flag). A value of the mpm flag may specify that the intra prediction mode for the current block is in the mpm candidates (and the planar mode), and a value 0 of the mpm flag may specify that the intra prediction mode for the current block is not in the mpm candidates (and the planar mode). The value 0 of the not planar flag (e.g., intra_luma_not_planar_flag) may specify that the intra prediction mode for the current block is a planar mode, and the value 1 of the not planar flag may specify that the intra prediction mode for the current block is not a planar mode.

The mpm index may be signaled in the form of an mpm_idx or intra_luma_mpm_idx syntax element, and the remaining intra prediction mode information may be signaled in the form of a rem_intra_luma_pred_mode or intra_luma_mpm_remainder syntax element. For example, the remaining intra prediction mode information may specify one of the remaining intra prediction modes not included in the mpm candidates (and the planar mode) among all intra prediction modes, which are indexed in the order of prediction mode numbers. The intra prediction mode may be an intra prediction mode for a luma component (sample).

Hereinafter, the intra prediction mode information may include at least one of the mpm flag (e.g., intra_luma_mpm_flag), the not planar flag (e.g., intra_luma_not_planar_flag), the mpm index (e.g., mpm_idx or intra_luma_mpm_idx) or the remaining intra prediction mode information (rem_intra_luma_pred_mode or intra_luma_mpm_remainder). In the present disclosure, the MPM list may be called various terms such as MPM candidate list, candModeList, etc. When MIP applies to the current block, a separate mpm flag (e.g., intra_mip_mpm_flag) for MIP, an mpm index (e.g., intra_mip_mpm_idx) and remaining intra prediction mode information (e.g., intra_mip_mpm_remainder) may be signaled, and the not planar flag may not be signaled.

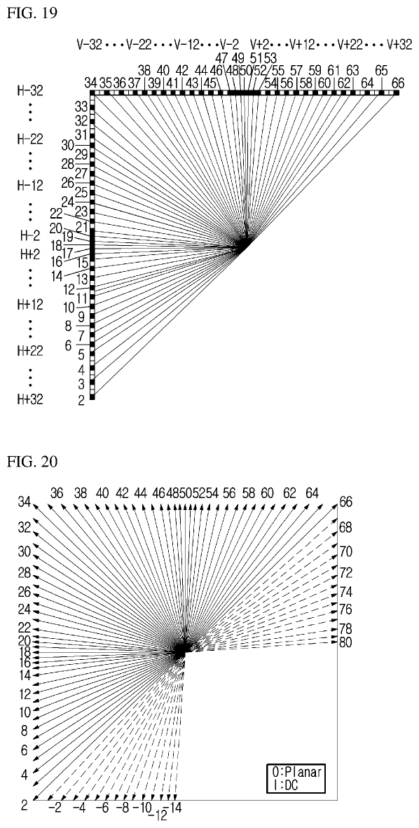

Meanwhile, the intra prediction modes may include two directional intra prediction modes and 65 directional prediction modes shown in FIG. 19. The non-directional intra prediction modes may include a planar intra prediction mode and a DC intra prediction mode, and the directional intra prediction modes may include intra prediction modes #2 to #66. Extended directional intra prediction is applicable to blocks having all sizes and is applicable to both a luma component and a chroma component.

Wide-Angle Intra Prediction for Non-Square Block

As described above with reference to FIG. 19, a prediction direction of intra prediction may be defined as 45 degrees to −135 degrees in a clockwise direction. However, according to an embodiment, as shown in FIG. 20, more prediction directions may be used. FIG. 20 shows wide-angle intra prediction directions for a non-square block and shows 93 prediction directions. In FIG. 20, prediction directions indicated by dashed lines indicate prediction directions for wide-angle intra prediction for the non-square block.

In an embodiment, when the current block is a non-square block, some existing directional intra prediction modes may be adaptively replaced with wide-angle intra prediction modes. When applying the replaced wide-angle intra prediction, information on existing intra prediction may be signaled and, after the information is parsed, the information may be remapped to the index of the wide-angle intra prediction mode. Accordingly, a total number of intra prediction modes for a specific block (e.g., a non-square block having a specific size) may not be changed, that is, a total number of intra prediction modes is 67, and intra prediction mode coding for the specific block may not be changed.

Reference Sample Filtering and Interpolation Filtering in Intra Prediction

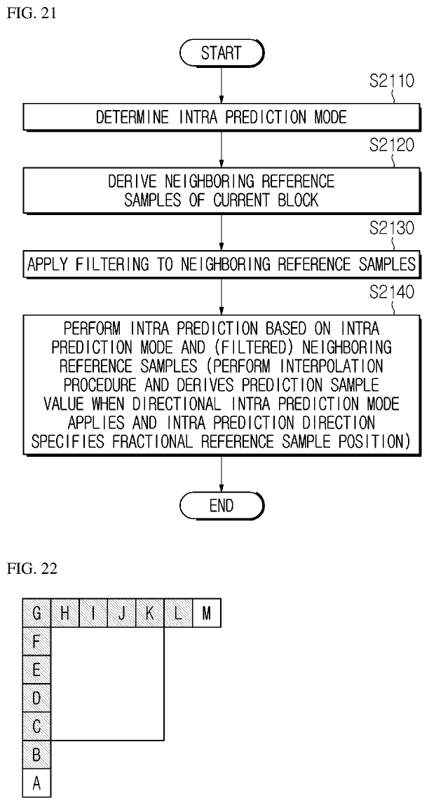

FIG. 21 is a view schematically illustrating an embodiment of an intra prediction method. An encoding apparatus and/or a decoding apparatus according to an embodiment may determine an intra prediction mode of a current block (S2110). Next, the encoding apparatus and/or the decoding apparatus may derive neighboring reference samples of the current block (S2120). Next, the encoding apparatus and/or the decoding apparatus may apply filtering to the neighboring reference samples (S2130). For example, the encoding apparatus and/or the decoding apparatus may determine whether to apply filtering to the neighboring reference samples as described below and apply filtering accordingly. Therefore, step S2130 may selectively apply. Next, the encoding apparatus and/or the decoding apparatus may perform intra prediction based on the intra prediction mode and (filtered) neighboring reference samples (S2140). For example, the encoding apparatus and/or the decoding apparatus may perform interpolation filtering and derive a prediction sample value, when a directional intra prediction mode applies and an intra prediction direction specifies a fractional reference sample position. The encoding apparatus and/or the decoding apparatus may determine an interpolation filter type as described below.

As described above, the encoding apparatus may derive prediction samples of the current block through intra prediction and derive residual samples based on the same. Information on the residual samples may be further included in the image/video information and encoded. In addition, the decoding apparatus may derive prediction samples of the current block and generate reconstructed samples based on the derived prediction samples. Based on this, a reconstructed picture may be generated.

Neighboring Reference Sample Derivation

When intra prediction applies to the current block, neighboring reference samples to be used for intra prediction of the current may be derived. The neighboring reference samples of the current block may be derived as described with reference to FIG. 16. Meanwhile, when MRL applies, the reference samples may be located at Line 1 to 3 instead of Line 0 adjacent to the current block on the left/upper side, and, in this case, the number of neighboring reference samples may further increase. In addition, when ISP applies, the neighboring reference samples may be derived in units of subpartitions.

Meanwhile, some of the neighboring reference samples of the current block may not yet be decoded or may not be available. In this case, the decoding apparatus may construct neighboring reference samples to be used for prediction through interpolation of available samples. Alternatively, the decoding apparatus may construct neighboring reference samples to be used for prediction through extrapolation of available samples. While referenceable sample is updated with the latest sample (last available sample) from a bottom-left reference sample to a top-right reference sample, it may be constructed by substituting or padding a pixel, which has not yet been decoded or is not available, with a last available sample.

Meanwhile, filtering is applicable to the neighboring reference samples of the current block. This may be called pre filtering in that it applies to the neighboring reference samples before intra prediction, unlike post filtering which is filtering applying to the prediction sample after intra prediction. Filtering of the neighboring reference samples may be performed using a 1-2-1 filter and thus may be called smooth filtering.

When the 1-2-1 filter applies to the neighboring reference sample, the value of the neighboring reference sample p[x][y], to which the filter for the neighboring reference sample refUnfilt[ ][ ] to which filtering does not apply applies, may be derived as follows. Here, [x][y] may specify (x, y) coordinates when the top-left sample position of the current block is (0, 0). Here, x=−1, y=−1 . . . refH−1 and x=0 . . . refW−1, y=−1.

p[−1][−1]=(refUnfilt[−1][0]+2*refUnfilt[−1][−1]+refUnfilt[0][−1]+2)>>2

p[−1][y]=(refUnfilt[−1][y+1]+2*refUnfilt[−1][y]+refUnfilt[−1][y−1]+2)>>2 for y=0 . . . refH−2

p[−1][refH−1]=refUnfilt[−1][refH−1]

p[x][−1]=(refUnfilt[x−1][−1]+2*refUnfilt[x][−1]+refUnfilt[x+1][−1]+2)>>2 for x=0 . . . refW−2

p[refW−1][−1]=refUnfilt[refW−1][−1] [Equation 1]

When filtering applies to the neighboring reference samples, the filtered neighboring reference samples may be used as reference samples in a prediction sample derivation step, and, when filtering does not apply to the neighboring reference samples, the unfiltered neighboring reference samples may be used as reference samples in the prediction sample derivation step.

The filtering of the neighboring reference samples may apply, for example, when some or all of the following specific conditions are satisfied.

The filtering of the neighboring reference samples may apply, for example, when some or all of the following specific conditions are satisfied.

(Condition 1) nTbW*nTbH is greater than 32. Here, nTbW denotes the width of a TB, that is, the width of a transform block (current block), and nTbH denotes the height of a TB, that is, the height of the transform block (current block).

(Condition 2) A value of cIdx is 0. cIdx denotes a color component of the current block and a value of 0 denotes a luma component.

(Condition 3) IntraSubPartitionsSplitType denotes non-split (ISP_NO_SPLIT). Here, IntraSubPartitionsSplitType is a parameter specifying a split type of a current luma coding block.

(Condition 4) At least one of Conditions 4-1 to 4-4 below is true.

(Condition 4-1) A value of predModeIntra specifying an intra prediction mode specifies a planar prediction mode (INTRA_PLANAR).

(Condition 4-2) A value of predModeIntra specifies directional intra prediction mode #34 (INTRA_ANGULAR34).

(Condition 4-3) A value of predModeIntra specifies directional intra prediction mode #2 (INTRA_ANGULAR2) and a value of nTbH is greater than or equal to a value of nTbW.

(Condition 4-4) A value of predModeIntra specifies directional intra prediction mode #66 (INTRA_ANGULAR66) and a value of nTbW is greater than or equal to nTbH.

Intra Prediction Mode/Type Based Prediction Sample Derivation

As described above, the prediction unit of the encoding/decoding apparatus may derive a reference sample according to an intra prediction mode of the current block among the neighboring reference samples of the current block, and generate the prediction sample of the current block based on the reference sample. For example, in case of a non-directional mode (non-angular mode), the prediction sample may be derived based on an average or interpolation of the neighboring reference samples of the current block. Alternatively, in case of a directional mode (angular mode), the prediction sample may be derived based on a reference sample in a specific (prediction) direction for the prediction sample among the neighboring reference samples of the current block.

Application of Interpolation Filter for Generating Prediction Sample

Meanwhile, when the prediction sample of the current block is generated through interpolation of the reference samples, an interpolation filter for interpolation may be derived through various methods. For example, the interpolation filter may be determined based on a predetermined condition. For example, the interpolation filter may be determined based on the intra prediction mode for the current block and/or the size of the current block. The interpolation filter may include, for example, a Gaussian filter and a Cubic filter. For example, when the intra prediction mode for the current block is a bottom-left diagonal intra prediction mode (#2), a top-left diagonal intra prediction mode (#34) or a top-right diagonal intra predict ion mode (#66), it may be determined that the interpolation filter does not apply or the Gaussian filter applies instead of the Cubic filter. In addition, for example, when the reference line index of the MRL is 0, the Cubic filter applies and, when the reference line index is greater than 0, it may be determined that the interpolation filter does not apply or the Gaussian filter applies. In addition, in the intra prediction mode, when a prediction direction according to an intra prediction mode specifies a fractional sample point instead of an integer sample point of the neighboring reference samples based on the position of the current prediction sample, the interpolation filter may apply to generate a reference sample value corresponding to the fractional sample point.

MDIS (Mode Dependent Intra Smoothing)

Meanwhile, when a prediction direction according to an intra prediction mode specifies a fractional sample point instead of an integer sample point of the neighboring reference samples based on the position of a current prediction sample (target prediction sample) in a current block, the interpolation filter may apply to generate the reference sample value corresponding to the fractional sample point. For example, a 4-tap intra interpolation filter may be used to increase directional intra prediction accuracy.

For example, the type of the 4-tap filter may be determined according to the aspect of applying the directional intra prediction mode. The directional intra prediction mode may be classified into the following three groups.
Group A: vertical prediction mode (HOR_IDX) or horizontal prediction mode (VER_IDX)
Group B: diagonal prediction mode (2, DIA_IDX, VDIA_IDX) having a directional angle determined to be a multiple of 45 degrees
Group C: other directional prediction modes

For the directional intra prediction mode for Group A, filtering may not apply, in a process of generating a prediction sample using a reference sample. For the directional intra prediction mode for Group B, [1, 2, 1] reference sample filtering may apply to the value of the reference sample itself. Thereafter, intra prediction may be performed by copying, to the intra prediction sample value, a reference sample value, to which filtering applies, without applying the interpolation filter. For the directional intra prediction mode for Group C, reference sample filtering using a [1, 2, 1] filter for the reference sample may not apply. However, the interpolation filter may apply in a process of deriving an intra prediction sample value based on a reference sample value.

Condition for Performing Reference Sample Filtering and Interpolation Filtering

Hereinafter, a condition for performing, in intra prediction, reference sample filtering by the encoding apparatus and/or the decoding apparatus and a method of determining an interpolation filter type will be described. In the following description, a process of determining whether to perform reference sample filtering and a process of determining a type of an interpolation filter may be simplified. Therefore, by decreasing algorithm complexity for determining whether to perform reference sample filtering or determining a type of an interpolation filter, it is possible to decrease performance requirements of the encoding apparatus and the decoding apparatus and to increase encoding and decoding throughput.

When the intra prediction mode is a directional prediction mode, the encoding apparatus and/or the decoding apparatus may derive a prediction sample value of a target sample using a neighboring reference sample located in an intra prediction direction from a target sample position in the current block. In this case, the encoding apparatus and/or the decoding apparatus may derive the prediction sample value of the target sample by extrapolating an integer reference sample value when the intra prediction direction specifies the integer reference sample position as described above, and derive the prediction sample value of the target sample through interpolation using integer reference samples around a fractional reference sample position when the intra prediction direction specifies the fractional reference sample position.

As described above, a condition for performing reference sample filtering and a condition for determining an interpolation filter type may be variably determined in consideration of a current intra prediction type, a current intra mode and a size of a block. The following table shows an embodiment of determining a condition for performing reference sample filtering and an interpolation filter type.

TABLE 2

| Intra prediction | | |
|---|---|---|
| type and intra | Condition for performing reference sample filtering and condition for | |
| mode | determining interpolation filter type | |
| Chroma, ISP, | Reference sample filtering condition (refFilterFlag): not performed | |
| MRL, MIP, DC | (false) | |
| mode | * interpolation filter type (interpolationFlag): DCT-IF(false) | |
| BDPCM | Reference sample filtering condition (refFilterFlag): not performed | |
| | (false) | |
| | * interpolation filter type (interpolationFlag): DCT-IF(false) | |
| planar mode | Reference sample filtering condition (refFilterFlag): | |
| | Width of block * height of block > 32 => performed (true) | |
| | Width of block * height of block ≤ 32 => not performed (false) | |
| Directional | diff = min (abs(intra prediction mode index − horizontal mode index), | |
| mode | abs(intra prediction mode index − vertical mode index)) | |
| | filter condition (filterFlag) = (diff > intra filter threshold value [block | |
| | size]) | |
| | filter condition (filterFlag): satisfied | filter condition (filterFlag): |
| | (true) | not satisfied (false) |
| | reference sample filtering condition | reference sample filtering |
| | (refFilterFlag): isIntegerSlop | condition (refFilterFlag): not |
| | * interpolation filter type | performed (false) |
| | (interpolationFlag): !isIntegerSlop | * interpolation filter type |
| | | (interpolationFlag): DCT- |
| | | IF(false) |

As shown in the above table, when the current intra prediction type is a chroma component intra prediction (Chroma), subpartition intra prediction (ISP), multiple reference line intra prediction (MRL), matrix based intra prediction (MIP) or DC mode, reference sample filtering is not performed, and interpolation may be performed using a DCT-IF filter (also referred to as a Cubic filter) when generating a prediction block. Alternatively, when the current block type is BDPCM, reference sample filtering is not performed, and interpolation may be performed using a DCT-IF filter when generating a prediction block. Alternatively, when the current intra prediction mode is a planar mode, the encoding apparatus and/or the decoding apparatus may determine the reference sample filtering condition according to a product of the width and height of the block. For example, the encoding apparatus and/or the decoding apparatus may perform reference sample filtering when the product of the width and height of the block is greater than 32 and, otherwise, may not perform reference sample filtering.

Finally, when existing intra prediction is performed with respect to the current block and the intra prediction mode is a directional (angular) mode, the encoding apparatus and/or the decoding apparatus may determine the reference sample filtering condition and the interpolation filter type according to the filter condition. The filter condition may be variably determined based on the current intra prediction mode and the size of the block, as described in the above table. For example, the filter condition may be determined according to the following condition.

diff=min(abs(predMode−HDR_IDX),abs(predMode−VER_IDX))

log 2Size=((g_auc Log 2[puSize.width]+g_auc Log 2[puSize.height])>>1)

filterFlag=(diff>m_aucIntraFilter[log 2Size])[Equation2]

In the above equation, min(A, B) denotes a function for returning the smaller value of A and B, abs(A) is a function for returning an absolute value of A, predMode denotes an index of a current directional intra prediction mode, HDR_IDX denotes an index of a horizontal intra prediction mode, VER_IDX denotes an index of a vertical intra prediction mode, g_aucLog2[puSize.width] represents the width of the current prediction block with a logarithm with a base of 2, g_aucLog2[puSize.height] represents the height of the current prediction block with a logarithm with a base of 2, and m_aucIntraFilter[log 2Size] represents an intra filter threshold value for a block size log 2Size.

The encoding apparatus and/or the decoding apparatus may determine the reference sample filtering condition and the interpolation filter type using different methods according to the determined filter condition. For example, as shown in the above table, when intra prediction is performed, the intra prediction mode is a directional mode and the filter condition shown in the above table is satisfied, the reference sample filtering condition and the interpolation filter type may be determined depending on whether directionality of the current intra prediction mode is directionality isIntegerSlop of an integer pixel. For example, when directionality of the current intra prediction mode is directionality of an integer pixel, the encoding apparatus and/or the decoding apparatus may perform reference sample filtering and use a DCT-IF filter as an interpolation filter. Otherwise, the encoding apparatus and/or the decoding apparatus may use a Gaussian filter as an interpolation filter without performing reference sample filtering. Meanwhile, when existing intra prediction is performed, the intra prediction mode is a directional mode and the filter condition of the above table is not satisfied, the encoding apparatus and/or the decoding apparatus may use a DCT-IF filter as an interpolation filter without performing reference sample filtering.

The condition for performing reference sample filtering and the condition for determining the interpolation filter type shown in the above table are respectively determined in consideration of an intra prediction type, an intra prediction mode and a size of a block and thus has high complexity. For example, after determining whether to perform intra prediction and determining whether an intra prediction mode is a directional prediction mode, the encoding apparatus and/or the decoding apparatus determines the condition for performing the reference sample filtering and the condition for determining the interpolation filter type using different methods by internally considering the filter condition again, the directional prediction mode is not unified compared to other intra prediction mode other than the directional prediction mode, and algorithm complexity is also high.

In the embodiment disclosed below, when intra prediction is performed as described above and it is a directional mode, the condition for performing reference sample filtering and the condition for determining the interpolation filter type are set using a simple and unified method. In the following embodiment, by using the condition for performing simpler and unified reference sample filtering and the condition for determining the interpolation filter type, intra prediction complexity in the encoding/decoding process may be reduced.

### Embodiment 1

The embodiment disclosed below improves a method of determining reference sample filtering and an interpolation filter type in a directional mode in the embodiment according to Table 2 above. Accordingly, by using a simpler and unified condition for performing reference sample filtering and condition for determining an interpolation filter type compared to the embodiment of Table 2 above, it is possible to reduce intra prediction complexity in an encoding/decoding process.

TABLE 3

| Intra prediction | | |
|---|---|---|
| type and intra | Condition for performing reference sample filtering and condition for | |
| mode | determining interpolation filter type | |
| Chroma, ISP, | reference sample filtering condition (refFilterFlag): not performed | |
| MRL, MIP, DC | (false) | |
| mode | * interpolation filter type (interpolationFlag): DCT-IF(false) | |
| BDPCM | reference sample filtering condition (refFilterFlag): not performed | |
| | (false) | |
| | * interpolation filter type (interpolationFlag): DCT-IF(false) | |
| planar mode | reference sample filtering condition (refFilterFlag): | |
| | Width of block * height of block > 32 => performed (true) | |
| | Width of block * height of block ≤ 32 => not performed (false) | |
| Directional mode | diff = min (abs(intra prediction mode index − horizontal mode | |
| | index), abs(intra prediction mode index − vertical mode index)) | |
| | filter condition (filterFlag) = (diff > intra filter threshold value [block | |
| | size]) | |
| | filter condition (filterFlag): | filter condition (filterFlag): not |
| | satisfied (true) | satisfied (false) |
| | reference sample filtering | reference sample filtering |
| | condition (refFilterFlag): not | condition (refFilterFlag): not |
| | performed (false) | performed(false) |
| | * interpolation filter type | * interpolation filter type |
| | (interpolationFlag): | (interpolationFlag): DCT- |
| | Gaussian(true) | IF(false) |

As disclosed in the above table, the encoding apparatus and/or the decoding apparatus may not perform reference sample filtering regardless of the filter condition, when a directional intra prediction mode applies. This is based on Level-O Gaussian filter deriving the same filtering effect as the [1, 2, 1] filter. That is, when the Gaussian filter applies, reference sample filtering based on the [1, 2, 1] filter may not apply. Therefore, the encoding apparatus and/or the decoding apparatus may not determine the condition for performing reference sample filtering in the directional mode. For example, the encoding apparatus may not use flag information refFilterFlag specifying whether to perform reference sample filtering in the directional mode and thus may not signal information on it to the decoding apparatus. Therefore, in a process of performing intra prediction, reference sample filtering may apply only in a planar mode. In this regard, whether to apply reference sample filtering in the process of performing intra prediction may be simply determined based on the size of the block only in the planar mode.

Meanwhile, the encoding apparatus and/or the decoding apparatus may use a Gaussian filter as an interpolation filter when the filter condition is satisfied. The Gaussian filter has smoothing characteristics. The encoding apparatus and/or the decoding apparatus may use a DCT-rF filter as an interpolation filter when the filter condition is not satisfied. Therefore, the encoding apparatus and/or the decoding apparatus may determine an interpolation filter without determining a condition using isIntegerSlop as shown in Table 2.

### Embodiment 2

The embodiment disclosed below improves a method of determining reference sample filtering and an interpolation filter type in a directional mode in the embodiment according to Table 2 above. Accordingly, by using a simpler and unified condition for performing reference sample filtering and condition for determining an interpolation filter type compared to the embodiment of Table 2 above, it is possible to reduce intra prediction complexity in an encoding/decoding process.

TABLE 4

| Intra prediction | |
|---|---|
| type and intra | Condition for performing reference sample filtering and condition for |
| mode | determining interpolation filter type |
| Chroma, ISP, | reference sample filtering condition (refFilterFlag): not performed |
| MRL, MIP, DC | (false) |
| mode | * interpolation filter type (interpolationFlag): DCT-IF(false) |
| BDPCM | reference sample filtering condition (refFilterFlag): not performed |
| | (false) |
| | * interpolation filter type (interpolationFlag): DCT-IF(false) |
| planar mode | reference sample filtering condition (refFilterFlag): |
| | luma CB size(e.g. width of block * height of block) > 32 => |
| | performed (true) |
| | luma CB size(e.g. width of block * height of block) ≤ 32 => not |
| | performed (false) |
| Directional mode | reference sample filtering condition (refFilterFlag):isIntegerSlop |
| | interpolation filter type (interpolationFlag): |
| | nTBS > 3 => !isIntegerSlop |
| | nTBS ≤ 3 => DCT-IF |

As disclosed in the above table, the encoding apparatus and/or the decoding apparatus may determine the reference sample filtering condition with the value of isIntegerSlop regardless of the size of the current block, when applying the directional intra prediction mode. In addition, the encoding apparatus and/or the decoding apparatus may determine an interpolation filter type according to the value of isIntegerSlop if a product of the width and height of the current block is greater than 256 (e.g., nTbS>3), when the directional intra prediction mode applies. For example, when directionality of the current intra prediction mode has directionality of an integer pixel (e.g., isIntegerSlop==1), the encoding apparatus and/or the decoding apparatus may perform reference sample filtering and use a DCT-IF filter as an interpolation filter. Otherwise, the encoding apparatus and/or the decoding apparatus may use a Gaussian filter as an interpolation without performing reference sample filtering. Meanwhile, when the product of the width and height of the current block is not greater than 256 (e.g., nTbS<3), the interpolation filter may be determined to be a DCT-IF. Meanwhile, a size threshold value (e.g., the threshold value of the product of the width and height of the current block or nTbS) of the current block for determining the interpolation filter may be determined to be a predetermined value as necessary. Therefore, the encoding apparatus and/or the decoding apparatus may set the condition for performing reference sample filtering and the condition for determining the interpolation filter type using a simple method while considering the mode information and size information of the current block.

### Embodiment 3

The embodiment disclosed below improves a method of determining whether to perform reference sample filtering in a planar mode in the above-described embodiments. Accordingly, by using a condition for performing simpler reference sample filtering compared to the above-described embodiments, it is possible to reduce intra prediction complexity in an encoding/decoding process.

In the above-described embodiments, as shown in the following equation, whether to perform reference sample filtering for the planar mode was determined.

refFilterFlag=luma CB size>32?true:false [Equation 3]

In the above equation, refFilterFlag is a parameter specifying whether to perform reference sample filtering, a first value (e.g., 0) specifies that reference sample filtering is not performed, and a second value (e.g., 1) may specify that reference sample filtering is performed. A luma CB size may specify a size of a current luma component coding block (CB) and may be calculated by a product of a width and height of the CB.

In order to calculate reference sample filtering for the planar mode according to the above equation, since size information of the current block is determined and whether the size is greater than a predetermined value (e.g., 32), complexity occurs.

By removing dependency on the size of the current block, it is possible to unify and simplify the condition for performing reference sample filtering for the planar mode. For example, refFilterFlag may be determined as shown in the following equation.

refFilterFlag=true [Equation 4]

Alternatively, refFilterFlag may be determined as shown in the following equation.

refFilterFlag=false [Equation 5]

The encoding apparatus and/or the decoding apparatus according to an embodiment may reduce algorithm complexity, by performing simplification to unconditionally apply or not to apply whether to apply a reference sample for the planar mode.

### Embodiment 4

The embodiment disclosed below improves a method of determining reference sample filtering and an interpolation filter type in a directional mode in the embodiment according to Table 2 above. Accordingly, by using a simpler and unified condition for performing reference sample filtering and condition for determining an interpolation filter type compared to the embodiment of Table 2 above, it is possible to reduce intra prediction complexity in an encoding/decoding process.

TABLE 5

| Intra prediction | |
|---|---|
| type and intra | Condition for performing reference sample filtering and condition for |
| mode | determining interpolation filter type |
| Chroma, ISP, | reference sample filtering condition (refFilterFlag): not performed |
| MRL, MIP, DC | (false) |
| mode | * interpolation filter type (interpolationFlag): DCT-IF(false) |
| BDPCM | reference sample filtering condition (refFilterFlag): not performed |
| | (false) |
| | * interpolation filter type (interpolationFlag): DCT-IF(false) |
| planar mode | reference sample filtering condition (refFilterFlag): |
| | Width of block * height of block (e.g. pu.width * pu.height) > 32 => |
| | performed (true) |
| | Width of block * height of block (e.g. pu.width * pu.height) ≤ 32 => |
| | not performed (false) |
| Directional mode | log2Size = ((g_aucLog2[puSize.width] + |
| | g_aucLog2[puSize.height])>>1) |
| | If(log2Size > 3){ |
| | reference sample filtering condition (refFilterFlag):isIntegerSlop |
| | interpolation filter type (interpolationFlag): !isIntegerSlop |
| | } |

As disclosed in the above table, the encoding apparatus and/or the decoding apparatus may remove a directional mode based intra filter selection condition filterFlag and set a condition refFilterFlag for performing reference sample filtering and a condition for determining an interpolation filter type interpolationFlag according to the size log 2Size of the current block. As shown in the above table, when the current intra prediction mode is a directional mode, the condition for performing reference sample filtering and the condition for determining the interpolation filter type may be determined in consideration of only the size of the current block. For example, when the size of the current block is greater than a predetermined size (e.g., 3), the condition refFilterFlag for performing reference sample filtering and the condition interpolationFlag for determining the interpolation filter type may be determined based on directionality of the current intra prediction mode. For example, they may be determined based on the value of isIntegerSlop. The predetermined size may be arbitrarily determined as necessary. Therefore, the encoding apparatus and/or the decoding apparatus may set the condition for performing reference sample filtering and the condition for determining the interpolation filter type using a simple method while considering the mode information and size information of the current block.

### Embodiment 5

The embodiment disclosed below improves a method of determining reference sample filtering and an interpolation filter type when an intra prediction mode is a planar mode or a directional mode in the embodiment according to Table 2 above. Accordingly, by using a simpler and unified condition for performing reference sample filtering and condition for determining an interpolation filter type compared to the embodiment of Table 2 above, it is possible to reduce intra prediction complexity in an encoding/decoding process.

TABLE 6

| Intra prediction | | |
|---|---|---|
| type and intra | Condition for performing reference sample filtering and condition for | |
| mode | determining interpolation filter type | |
| Chroma, ISP, | * interpolation filter type (interpolationFlag): DCT-IF(false) | |
| MRL, MIP, DC | | |
| mode | | |
| BDPCM | * interpolation filter type (interpolationFlag): DCT-IF(false) | |
| planar mode | | |
| Directional mode | diff = min (abs(intra prediction mode index − horizontal mode | |
| | index), abs(intra prediction mode index − vertical mode index)) | |
| | filter condition (filterFlag) = (diff > intra filter threshold value [block | |
| | size]) | |
| | filter condition (filterFlag): | filter condition (filterFlag): not |
| | satisfied (true) | satisfied (false) |
| | * interpolation filter type | * interpolation filter type |
| | (interpolationFlag): | (interpolationFlag): DCT- |
| | Gaussian(true) | IF(false) |

As shown in the above table, a condition for performing reference sample filtering in intra prediction may be removed. For example, reference sample filtering may not be performed in intra prediction in all cases. Therefore, as described in the above table, use of refFilterFlag which is the condition for performing reference sample filtering may be skipped. Accordingly, the encoding apparatus and the decoding apparatus may perform intra prediction using a reconstructed reference sample without change. In addition, the interpolation filter may be selected as one of a Gaussian filter (e.g., a 4-tap Gaussian filter) and a DCT-IF filter (e.g., 4-tap DCT-IF filter) according to the mode based intra filter condition. For example, when the mode based intra filter condition is satisfied, the 4-tap Gaussian filter may be used and, otherwise, the 4-tap DCT-IF filter may be used. Therefore, since reference sample filtering is not performed in the intra prediction process, the condition for performing reference sample filtering may be removed. Further, the reference sample filtering process may be removed, thereby performing intra prediction using a more simplified method. In addition, since the interpolation filter is directly determined according to the mode based intra filter condition, the intra reference sample filter may be selected using a simplified method.

### Embodiment 6

The embodiment disclosed below improves a method of improving prediction accuracy of a planar mode in Embodiment 5 described above. In Embodiment 5 above, the condition for performing reference sample filtering in intra prediction is removed. Accordingly, in all intra prediction types, refFilterFlag which is the condition for performing reference sample filtering is not present. As described above, when the intra mode of a block to be currently encoded is a directional mode, even though reference sample filtering is not performed, reference sample filtering effects may be obtained by efficiently selecting the type of the interpolation filter. For example, when the directional mode of current intra prediction is an integer directional mode, even though reference sample filtering is not performed, a Gaussian filter is selected as an interpolation filter and a Gaussian filter coefficient corresponding to the integer directional mode is 1:2:1:0 and is equal to the reference sample filtering coefficient of 1:2:1. Therefore, interpolation filtering using the Gaussian filter may obtain the same effect as reference sample filtering using the [1, 2, 1] filter.

However, in case of the planar mode, since a prediction block is generated using a linear interpolation method without using a 4-tap interpolation filter (DCT-IF filter or Gaussian filter), when the reference sample filtering process is removed, coding loss may occur. Accordingly, there is a need to compensate for loss caused by not performing reference sample filtering in the planar mode.

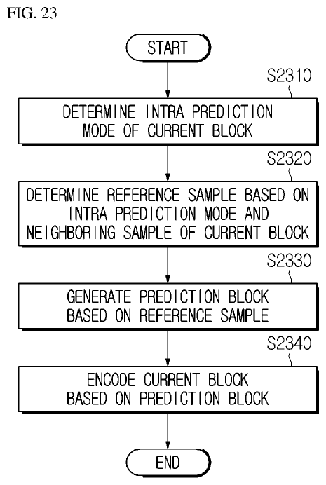

FIG. 22 is a view illustrating a neighboring reference sample used in a planar mode. It will be described with reference to FIG. 22. In FIG. 22, Sample B to Sample L specify reference samples used to generate the prediction block when a current block is a planar mode.

In an embodiment, filtering for a neighboring reference sample for the planar mode may be performed by applying filtering to all reference samples B to L used in the planar mode. The encoding apparatus and/or the decoding apparatus may perform planar prediction using a reference sample filtered accordingly.

Alternatively, in another embodiment, filtering for the neighboring reference sample for the planar mode may be performed by applying filtering to only a bottom-left sample B and a top-right sample L. Therefore, filtering is performed on only the top-left sample B and the top-right sample L among reference samples used for planar prediction, and filtering may not apply to the remaining reference samples C to K. The encoding apparatus and/or the decoding apparatus may perform planar prediction using the filtered reference sample. By restrictively applying filtering, it is possible to reduce coding loss of the planar mode caused by not performing reference sample filtering. In addition, by reducing the number of samples to be filtered, it is possible to reduce encoding/decoding complexity.

Encoding and Decoding Method

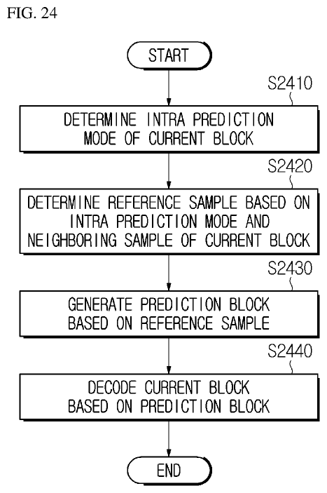

Hereinafter, an image encoding and decoding method performed by an image encoding apparatus and an image decoding apparatus will be described with reference to FIGS. 23 and 24. For example, as shown in FIG. 23, the image encoding apparatus according to an embodiment may include a memory and a processor and the encoding apparatus may perform encoding by the processor. For example, the encoding apparatus may determine an intra prediction mode of a current block (S2310). Next, the encoding apparatus may determine a reference sample based on the intra prediction mode and a neighboring sample of the current block (S2320). Next, the encoding apparatus may generate a prediction block based on the reference sample (S2330). Next, the encoding apparatus may encode the current block based on the prediction block (S2340).

In addition, as shown in FIG. 24, the image decoding apparatus according to an embodiment may include a memory and a processor and the decoding apparatus may perform decoding by the processor. For example, the decoding apparatus may determine an intra prediction mode of a current block (S2410). Next, the decoding apparatus may determine a reference sample based on the intra prediction mode and a neighboring sample of the current block (S2420). Next, the decoding apparatus may generate a prediction block based on the reference sample (S2430). Next, the decoding apparatus may decode the current block based on the prediction block (S2440).

In operation of the encoding apparatus and the decoding apparatus, the reference sample may be determined by applying at least one of first filtering or second filtering to the neighboring sample value based on the intra prediction mode. For example, when the intra prediction mode is a directional prediction mode, the reference sample may be determined by not applying first filtering to the neighboring sample value. In addition, the prediction sample may be determined by applying second filtering to the reference sample, and an interpolation filter used for second filtering may be determined based on a size of the prediction block. In this case, the interpolation filter used for second filtering may be determined by further considering a prediction direction specified by a directional prediction mode. For example, the interpolation filter used for second filtering may be determined depending on whether a minimum difference value is greater than a threshold value for determining the interpolation filter, and the minimum difference value may be determined to be the smaller value of a difference between a directional index value specified by the directional prediction mode and a horizontal prediction mode and a difference between a directional index value specified by the directional prediction mode and a vertical prediction mode. For example, when the minimum difference value is greater than the threshold value, the interpolation filter used for second filtering may be determined to be a Gaussian filter. Alternatively, when the minimum difference value is not greater than the threshold value, the interpolation filter used for second filtering may be determined to be a DCT-IF filter.

Meanwhile, when the intra prediction mode is a directional prediction mode, the reference sample may be determined by applying first filtering to the neighboring sample value based on whether the directional prediction mode specifies an intra prediction direction specifying an integer unit pixel.

In addition, when the intra prediction mode is a directional prediction mode, the reference sample may be determined by applying first filtering to the neighboring sample value based on whether the size of the current block is greater than a predetermined size. In this case, when the size of the current block is greater than the predetermined size, the interpolation filter used for second filtering may be determined based on whether the directional prediction mode specifies an intra prediction direction specifying an integer unit pixel.

In addition, when the intra prediction mode is a directional prediction mode, the prediction sample may be determined by applying second filtering to the reference sample, and the interpolation filter used for second filtering may be determined based on the size of the current block. In this case, when a product of the width and height of the current block is greater than a predetermined value, the interpolation filter used for second filtering may be determined based on whether the directional prediction mode specifies an intra prediction direction having an integer unit angle. Here, the size of the current block may be determined based on any one of the size of a coding block, a prediction block or a transform block corresponding to the current block. Here, the predetermined value may be 256.

In addition, when the intra prediction mode is a planar prediction mode, the reference sample may be determined by applying first filtering to the neighboring sample value. In this case, whether to apply first filtering may be determined based on the size of the prediction sample.

In addition, when the intra prediction mode is a planar prediction mode, the prediction block is generated based on a plurality of reference samples, and the plurality of reference samples may include a first reference sample generated by applying first filtering to a bottom-left sample of the current block, a second reference sample generated by applying first filtering to a top-right sample of the current block and a third reference sample generated by not applying first filtering to a top or left sample of the current block.

### Application Embodiment

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some steps.

In the present disclosure, the image encoding apparatus or the image decoding apparatus that performs a predetermined operation (step) may perform an operation (step) of confirming an execution condition or situation of the corresponding operation (step). For example, if it is described that predetermined operation is performed when a predetermined condition is satisfied, the image encoding apparatus or the image decoding apparatus may perform the predetermined operation after determining whether the predetermined condition is satisfied.

The various embodiments of the present disclosure are not a list of all possible combinations and are intended to describe representative aspects of the present disclosure, and the matters described in the various embodiments may be applied independently or in combination of two or more.

Various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

In addition, the image decoding apparatus and the image encoding apparatus, to which the embodiments of the present disclosure are applied, may be included in a multimedia broadcasting transmission and reception device, a mobile communication terminal, a home cinema video device, a digital cinema video device, a surveillance camera, a video chat device, a real time communication device such as video communication, a mobile streaming device, a storage medium, a camcorder, a video on demand (VoD) service providing device, an OTT video (over the top video) device, an Internet streaming service providing device, a three-dimensional (3D) video device, a video telephony video device, a medical video device, and the like, and may be used to process video signals or data signals. For example, the OTT video devices may include a game console, a blu-ray player, an Internet access TV, a home theater system, a smartphone, a tablet PC, a digital video recorder (DVR), or the like.

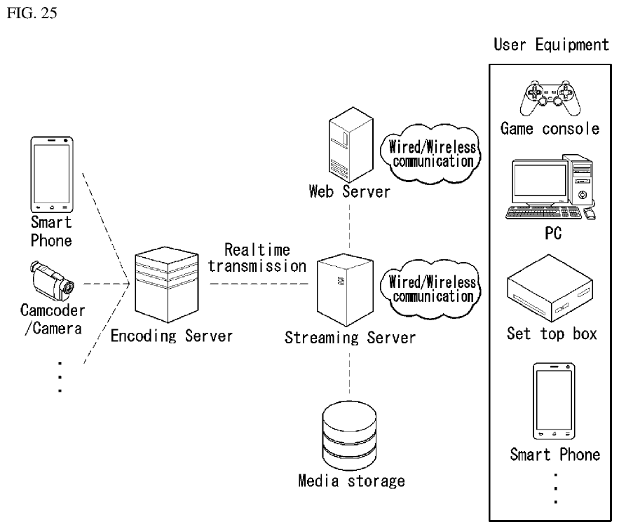

FIG. 25 is a view showing a content streaming system, to which an embodiment of the present disclosure is applicable.

As shown in FIG. 25, the content streaming system, to which the embodiment of the present disclosure is applied, may largely include an encoding server, a streaming server, a web server, a media storage, a user device, and a multimedia input device.

The encoding server compresses content input from multimedia input devices such as a smartphone, a camera, a camcorder, etc. into digital data to generate a bitstream and transmits the bitstream to the streaming server. As another example, when the multimedia input devices such as smartphones, cameras, camcorders, etc. directly generate a bitstream, the encoding server may be omitted.

The bitstream may be generated by an image encoding method or an image encoding apparatus, to which the embodiment of the present disclosure is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server may deliver it to a streaming server, and the streaming server may transmit multimedia data to the user. In this case, the content streaming system may include a separate control server. In this case, the control server serves to control a command/response between devices in the content streaming system.

The streaming server may receive content from a media storage and/or an encoding server. For example, when the content are received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (e.g., smartwatches, smart glasses, head mounted displays), digital TVs, desktops computer, digital signage, and the like.

Each server in the content streaming system may be operated as a distributed server, in which case data received from each server may be distributed.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

### INDUSTRIAL APPLICABILITY

The embodiments of the present disclosure may be used to encode or decode an image.

1. An image decoding method performed by an image decoding apparatus, the image decoding method comprising:
determining an intra prediction mode of a current block;
determining a reference sample based on the intra prediction mode and a neighboring sample of the current block;
generating the prediction block based on the reference sample; and
decoding the current block based on the prediction block,
wherein the reference sample is determined by applying at least one of first filtering or second filtering to the neighboring sample value based on the intra prediction mode.

2. The image decoding method of claim 1, wherein, based on the intra prediction mode being a directional prediction mode, the reference sample is determined by not applying the first filtering to the neighboring sample value.

3. The image decoding method of claim 2,
wherein the prediction sample is determined by applying the second filtering to the reference sample, and
wherein an interpolation filter used for the second filtering is determined based on a size of the prediction block.

4. The image decoding method of claim 3, wherein the interpolation filter used for the second filtering is determined by further considering a prediction direction specified by the directional prediction mode.

5. The image decoding method of claim 4,
wherein the interpolation filter used for the second filtering is determined depending on whether a minimum difference value is greater than a threshold value for determining an interpolation filter, and
wherein the minimum difference value is determined to be the smaller value of a difference between a directional index value specified by the directional prediction mode and a horizontal prediction mode and a difference between the directional index value specified by the directional prediction mode and a vertical prediction mode.

6. The image decoding method of claim 1, wherein, based on the intra prediction mode being a directional prediction mode, the reference sample is determined by applying the first filtering to the neighboring sample value based on whether the directional prediction mode specifies an intra prediction direction specifying an integer unit pixel.

7. The image decoding method of claim 1, wherein, based on the intra prediction mode being a directional prediction mode, the reference sample is determined by applying the first filtering to the neighboring sample value based on whether a size of the current block is greater than a predetermined size.

8. The image decoding method of claim 7, wherein, based on the size of the current block being greater than the predetermined size, an interpolation filter used for the second filtering is determined based on whether the directional prediction mode specifies an intra prediction direction specifying an integer unit pixel.

9. The image decoding method of claim 1,
wherein, based on the intra prediction mode being a directional prediction mode, the prediction sample is determined by applying the second filtering to the reference sample, and
wherein an interpolation filter used for the second filtering is determined based on a size of the current block.

10. The image decoding method of claim 9, wherein, based on a product of a width and height of the current block is greater than a predetermined value, the interpolation filter used for the second filtering is determined based on whether the directional prediction mode specifies an intra prediction direction having an integer unit angle.

11. The image decoding method of claim 1, wherein, based on the intra prediction mode being a planar prediction mode, the reference sample is determined by applying the first filtering to the neighboring sample value.

12. The image decoding method of claim 1,
wherein the prediction block is generated based on a plurality of reference samples, and
wherein the plurality of reference samples comprises a first reference sample generated by applying the first filtering to a bottom-left sample of the current block, a second reference sample generated by applying the first filtering to a top-right sample of the current block and a third reference sample generated by not applying the first filtering to a top or left sample of the current block.

13. An image decoding apparatus comprising:
a memory; and
at least one processor,
wherein the at least one processor is configured to:
determine an intra prediction mode of a current block;
determine a reference sample based on the intra prediction mode and a neighboring sample of the current block;
generate the prediction block based on the reference sample; and
decode the current block based on the prediction block,
wherein the reference sample is determined by applying at least one of first filtering or second filtering to the neighboring sample value based on the intra prediction mode.

14. An image encoding method performed by an image encoding apparatus, the image encoding method comprising:
determining an intra prediction mode of a current block;
determining a reference sample based on the intra prediction mode and a neighboring sample of the current block;
generating the prediction block based on the reference sample; and
encoding the current block based on the prediction block,
wherein the reference sample is determined by applying at least one of first filtering or second filtering to the neighboring sample value based on the intra prediction mode.

15. A method of transmitting a bitstream generated by the image encoding method of claim 14.
